(19) United States
(12) Patent Application Publication
(10) Pub. No.: US 2025/0181234 A1
(43) Pub. Date: Jun. 5, 2025

(54) INFORMATION PROCESSING SYSTEM AND SERVER SUPPORTING REMOTE DESKTOP, CONTROL METHODS THEREFOR, AND STORAGE MEDIA STORING CONTROL PROGRAMS THEREFOR

(71) Applicant: CANON KABUSHIKI KAISHA, Tokyo (JP)

(72) Inventors: ATSUSHI IKEDA, Ibaraki (JP); KOICHI YAMAMOTO, Kanagawa (JP)

(21) Appl. No.: 18/966,265

(22) Filed: Dec. 3, 2024

(30) Foreign Application Priority Data
Dec. 4, 2023 (JP) 2023-204679
Apr. 12, 2024 (JP) 2024-064559

(51) Int. Cl. G06F 3/0485; G06F 3/04845; G06F 3/0488; H04N 1/00

(52) U.S. Cl. CPC G06F 3/0485; G06F 3/04845; G06F 3/0488; H04N 1/00464; H04N 2201/0094

(57) ABSTRACT

An information processing system that quickly grasps a moving amount by a moving operation for moving a displayed image. The information processing system includes a server and an information processing apparatus including a display device and an operation device. When the operation device accepts the moving operation, operation information regarding the moving operation is transmitted to the server. The display device displays a first image before the moving operation and then displays a second image after the moving operation that includes a moved image in a state where the first image is moved and a blank image that becomes a blank in accordance with movement. The server generates a third image including an image corresponding to the moved image and an image continuously connected to the moved image based on the operation information. The display device displays the third image transmitted from the server after displaying the second image.

### BACKGROUND OF THE INVENTION

### Field of the Invention

The present invention relates to an information processing system and a server supporting a remote desktop, control method therefor, and storage media storing control programs therefor.

### Description of the Related Art

In the remote desktop, a screen displayed on a display unit varies according to an operation of a user, but latency in which a communication time delay occurs may be relatively large. In order to suppress the latency, there is a known remote desktop system in which an image of a wider range than a screen size is stored (cached) and a part of the image is extracted from a storage device to display a screen during a scroll operation (for example, see Japanese Patent Laid-Open Publication No. 2016-110335 (JP2016-110335A)).

However, since the remote desktop system disclosed in JP2016-110335A is configured to store an image wider than the screen size, it is difficult to cope with a screen having a header container that remains on the display even when a scroll operation is performed. Moreover, when a scroll operation is performed, it is difficult to quickly recognize a moving amount by the operation, or it is difficult to feel that the image has moved smoothly.

### SUMMARY OF THE INVENTION

The present invention provides an information processing system, a server, control methods therefor, and storage media storing computer programs, which enable to quickly grasp a moving amount by a moving operation when a user performs the moving operation for moving an image and to feel that the image has been smoothly moved.

An information processing system includes an information processing apparatus and a server communicably connected to the information processing apparatus. The information processing apparatus includes a display device that displays image data obtained from the server as an image, an operation device that accepts a moving operation by a user for moving the image displayed on the display device, an apparatus-side memory device that stores a set of instructions; and at least one apparatus-side processor that executes the set of instructions to transmit operation information regarding a moving amount by the moving operation to the server after the moving operation is ended, display the image before the moving operation as a first image on the display device, and display a second image in a case where the moving operation is applied to the first image. The second image includes a moved image in a state where the first image is moved by the moving operation and a blank image that becomes a blank in accordance with movement of the first image. The server includes a server-side memory device that stores a set of instructions, and at least one server-side processor that executes the set of instructions to receive the operation information from the information processing apparatus, generate image data of a third image including an image corresponding to the moved image and an image that is continuously connected to the moved image and fills the blank image based on the operation information received, and transmit the image data of the third image to the information processing apparatus. The at least one apparatus-side processor executes the set of instructions to displaying the third image based on the image data received from the server on the display device in place of the second image.

According to the present invention, when a user performs a moving operation for moving an image is performed, it is possible to quickly grasp a moving amount by the movement operation and to feel that the image has been smoothly moved.

Further features of the present invention will become apparent from the following description of exemplary embodiments with reference to the attached drawings.

### BRIEF DESCRIPTION OF THE DRAWINGS

FIG. 1 is a block diagram showing an entire configuration of a cloud browser system according to a first embodiment.

FIG. 2A is a block diagram showing an example of a hardware configuration of a virtual machine.

FIG. 2B is the block diagram showing an example of a software configuration of the virtual machine.

FIG. 3A is a block diagram showing an example of a hardware configuration of an image forming apparatus.

FIG. 3B is a block diagram showing an example of a software configuration of the image forming apparatus.

FIG. 4 is a view showing an example of a home screen displayed on an operation device of the image forming apparatus.

FIG. 5 is a view showing an example of a browser screen displayed on the operation device of the image forming apparatus.

FIG. 6A is a sequential chart showing an example of a process executed between the image forming apparatus, an image generation system, and an external site.

FIG. 6B is a sequential chart showing an example of a process executed between the image forming apparatus, the image generation system, and the external site.

FIG. 6C is a flowchart showing a processing (drag operation determination process) executed in the image forming apparatus.

FIG. 7 is a sequential chart showing an example of a process executed between the image forming apparatus, the image generation system, and the external site.

FIGS. 8A to 8G are views showing examples of images displayed on the operation device of the image forming apparatus.

FIGS. 9A to 9C are views showing examples of images displayed on the operation device of the image forming apparatus.

FIGS. 9D and 9E are views for describing a start point and an end point of an image moved by dragging.

FIGS. 10A and 10B are flowcharts showing processes executed by the image forming apparatus (a browser controller).

FIGS. 11A and 11B are sequential charts showing an example of a process executed between an image forming apparatus, an image generation system, and an external site in a cloud browser system according to a second embodiment.

FIGS. 12A to 12F are views showing examples of images displayed on an operation device of the image forming apparatus.

FIGS. 13A and 13B are views showing examples of frame information related to frame images.

FIG. 14 is a flowchart showing a process executed by the image generation system (a browser processor).

FIG. 15 is a flowchart showing a process executed by the image forming apparatus (browser controller).

FIGS. 16A to 16D are views showing examples of images displayed on an operation device of an image forming apparatus of a cloud browser system according to a third embodiment.

FIG. 17 is a sequential chart showing an example of a process executed between the image forming apparatus, an image generation system, and an external site.

FIG. 18 is a flowchart showing a process executed by the image generation system.

FIG. 19 is a flowchart showing a process executed by the image generation system at a timing different from an execution timing of the flowchart shown in FIG. 18.

FIG. 20 is a flowchart showing a process executed by an image generation system of a cloud browser system according to a fourth embodiment.

### DESCRIPTION OF THE EMBODIMENTS

Hereafter, embodiments according to the present invention will be described in detail by referring to the drawings. However, the configurations described in the following embodiments are merely examples, and the scope of the present invention is not limited by the configurations described in the embodiments. For example, each of sections constituting the present invention can be replaced with any configuration that can exhibit the same function. Further, an arbitrary component may be added. In addition, two or more arbitrary configurations (features) of the embodiments may be combined.

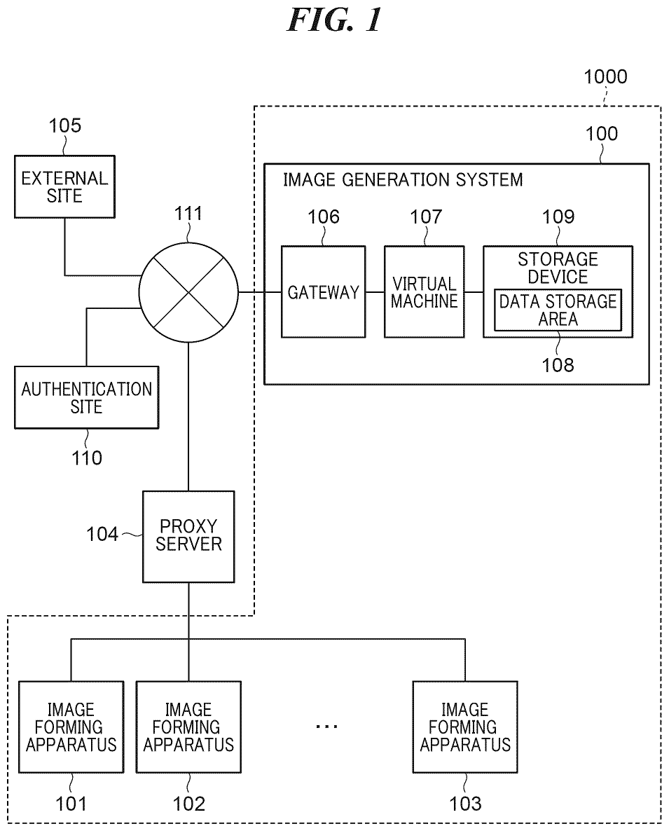

A first embodiment will now be described with reference to FIGS. 1 to 10B. FIG. 1 is a block diagram showing an entire configuration of a cloud browser system according to the first embodiment. The cloud browser system 1000 shown in FIG. 1 is the information processing system capable of processing various kinds of information. The cloud browser system 1000 includes a plurality of image forming apparatuses 101, 102, and 103 as the information processing apparatuses and an image generation system 100, which are communicably connected to each other. The cloud browser system 1000 is communicably connected to an external site 105 and an authentication site 110 via the Internet 111. Each of the image forming apparatuses 101, 102, and 103 is connected to the Internet 111 via a proxy server 104.

In this embodiment, the cloud browser system 1000 has the three image forming apparatuses 101, 102, 103, but the number of the image forming apparatuses arranged is not limited to this, and may be, for example, one, two, or four or more. Hereinafter, the image forming apparatus 101 is represented among the image forming apparatuses 101, 102, and 103. The cloud browser system 1000 includes one image generation system 100, but the number of image generation systems 100 to be arranged is not limited to this, and may be, for example, two or more. The number of the image generation systems 100 to be arranged is preferably smaller than the number of the image forming apparatuses to be arranged. In the cloud browser system 1000, the proxy server 104 may be omitted. For example, a user using the image forming apparatus 101 shall be viewing a screen displayed on the image forming apparatus 101. In this case, the user operates the image forming apparatus 101 to input a request for browsing the external site 105 to be browsed. In response to this, the image forming apparatus 101 transmits an address (URL) of the external site 105 to the image generation system 100 via the proxy server 104. The external site 105 is an http server that returns an http (Hyper Text Transfer Protocol) response to an http request, but the configuration thereof is not particularly limited.

The image generation system 100 is a server having a gateway 106, a virtual machine 107, and a storage device 109. A browser engine, which is a software module, operates on the virtual machine 107. The browser engine receives the URL of the external site 105 transmitted from the image forming apparatus 101 via the gateway 106. Then, the browser engine accesses the external site 105 corresponding to the URL via the gateway 106, and receives a Web content such as HTML from the external site 105. Thereafter, a rendering result of the Web content is generated by a software module that performs rendering. The rendering result is transmitted to the image forming apparatus 101 via the gateway 106. The image forming apparatus 101 receives the rendering result transmitted from the image generation system 100 and displays the rendering result. This allows a user to check the content of the external site 105. Here, “rendering” generally means displaying a browser screen (an image of a web site supplied from the external site 105) on the basis of a Web content. In this embodiment, the “rendering” indicates that the Web content such as HTML received from the external site 105 is converted into the image data of a predetermined screen size.

The storage device 109 stores user data such as a cookie obtained by the browser engine operating on the virtual machine 107 interpreting the web content received from the external site 105. The cloud browser system 1000 is configured to be communicable with the authentication site 110. Users using the image forming apparatuses 101, 102, and 103 can be identified by the authentication site 110. The image generation system 100 obtains authentication of a user on the basis of user information transmitted from any of the image forming apparatuses 101, 102, and 103. The image generation system 100 manages the user data stored in the storage device 109 for each authenticated user. In this embodiment, the image generation system 100 includes one virtual machine 107, but the number of virtual machines to be arranged is not limited thereto, and may include a plurality of virtual machines. In this case, it is preferable to arrange a load balancer between the gateway 106 and each virtual machine 107. Further, it is preferable to select one virtual machine 107 from among the plurality of virtual machines 107 in accordance with a load state. The storage device 109 is preferably used with the plurality of virtual machines 107.

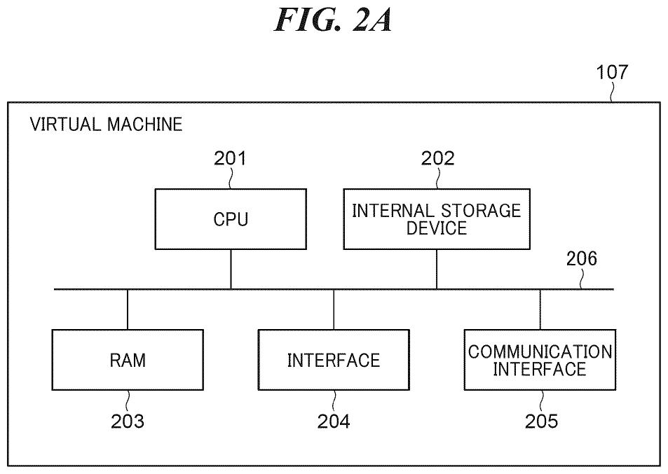

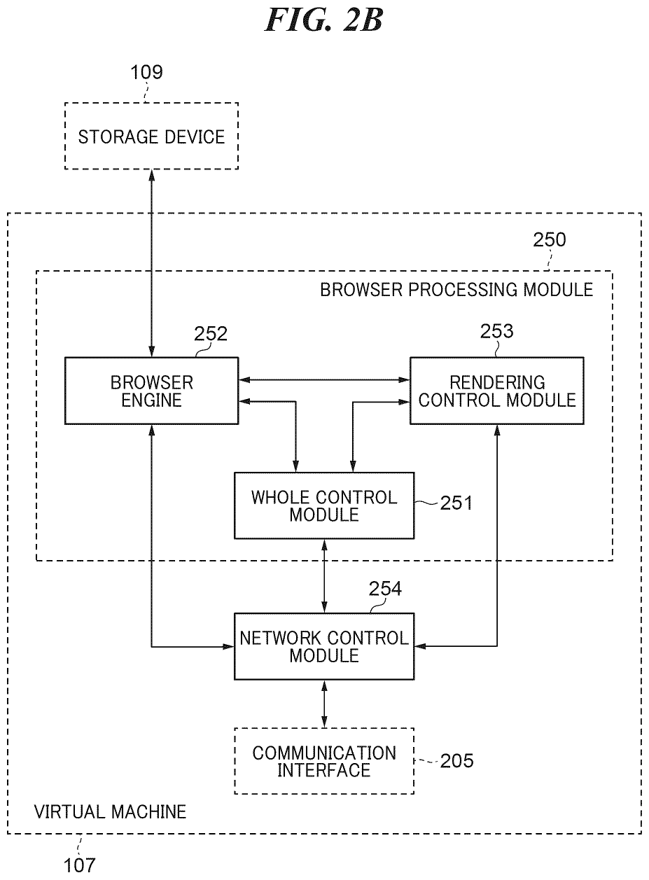

FIG. 2A is a block diagram showing an example of a hardware configuration of the virtual machine. As shown in FIG. 2A, the virtual machine 107 includes a CPU 201, an internal storage device 202, a RAM 203, an interface 204, and a communication interface 205 as hardware components and these are connected via a bus 206. The CPU 201 executes various processes using computer programs and data stored in the internal storage device 202. The computer programs include, for example, a program for causing a computer to execute each unit or each means (a control method for the information processing system and a control method for a server) in the cloud browser system 1000. This allows the CPU 201 to control the operation of the entire virtual machine 107. The internal storage device 202 stores setting data of the virtual machine 107, a computer program and data related to activation of the virtual machine 107, a computer program and data related to a basic operation of the virtual machine 107, etc. The RAM 203 has an area to store a computer program and data loaded from the internal the storage device 202, data received via the communication interface 205, etc. The RAM 203 also has a work area used when the CPU 201 executes various processes. In this way, the RAM 203 can provide various areas (storage areas) as appropriate. The interface 204 includes a display unit for displaying a result of a process executed by the CPU 201 with an image, characters, or the like, and an operation device operated by a user for performing various operation inputs. The display unit includes, for example, a liquid crystal screen and a touch panel screen. The operation device includes, for example, a keyboard, a mouse, a touch panel screen, etc. The communication interface 205 is an interface for performing the data communication with an external device. Specifically, the communication interface 205 can receive the image data from the image forming apparatuses 101 to 103 (a server-side reception step), and can transmit the image data to the image forming apparatuses 101, 102, and 103 (a server-side transmission step). As described above, the communication interface 205 in this embodiment has a function as a reception unit (a server-side reception unit) that receives the image data and a function as a transmission unit (a server-side transmission unit) that transmits the image data. In the virtual machine 107, a part functioning as the reception unit and a part functioning as the transmission unit may be provided separately.

The hardware configuration of the virtual machine 107 is not limited to the configuration shown in FIG. 2A, and for example, a memory device may be further connected to the bus 206. The memory device is not particularly limited, and examples thereof include a hard disk drive, a USB memory, a magnetic card, an optical card, an IC card, a memory card, and a drive device for a flexible disk (FD) or an optical disk such as a compact disk (CD). The virtual machine 107 can be configured by a virtualization technique, and can organize various resources constituting the computer system into logical units independently of a physical configuration.

FIG. 2B is a block diagram showing an example of a software configuration of the virtual machine. As shown FIG. 2B, the virtual machine 107 includes a browser processing module 250 and a network control module 254 as software. The browser processing module 250 includes a whole control module 251, a browser engine 252, and a rendering control module 253. The browser processing module 250 is a module that performs overall processes related to the browser executed on the image generation system 100 side, which is a cloud. The whole control module 251 is a module that controls the entire browser processing unit 250 operating on the virtual machine 107. When the user operates the image forming apparatus 101 to input a browsing request for the external site 105 that the user wants to browse, the URL of the external site 105 is transmitted from the image forming apparatus 101 to the image generation system 100 via the proxy server 104.

The whole control module 251 collectively receives various requests transmitted from the image forming apparatus 101. The whole control module 251 appropriately distributes the requests received from the image forming apparatus 101 to the browser engine 252 and the rendering control module 253. The browser engine 252 accesses the external site 105 via the network control module 254 on the basis of the URL transmitted from the whole control module 251. Thus, the Web content of the external site 105 can be obtained. The browser engine 252 includes a function of an http client required to obtain a Web content. The browser engine 252 can analyze the Web content, appropriately store information such as a cookie in the storage device 109, and refer to information such as a cookie stored in the storage device 109 in advance. When the analysis of the Web content is completed, the browser engine 252 requests the rendering control module 253 to perform a rendering process. The rendering control module 253 renders the Web content on the basis of the rendering request from the browser engine 252. The rendering control module 253 transmits a rendering result to the image forming apparatus 101, which is the request source of the URL, via the network control module 254. The network control module 254 is a module that relays communication between the browser processing module 250 and an external device such as the external site 105 or the authentication site 110 by controlling the communication interface 205. The network control module 254 includes a protocol stack of http communication required for access to the external site 105.

As described above, in the cloud browser system 1000, the user can input the browsing request for the external site 105 that the user wants to browse by operating the image forming apparatus 101. As a result, the URL of the external site 105 is transmitted from the image forming apparatus 101 to the image generation system 100 via the proxy server 104. The whole control module 251 receives the URL of the external site 105 and transfers it to the browser engine 252. This allows the browser engine 252 to receive the URL. Then, the browser engine 252 requests the network control module 254 to access the external site 105 indicated by the URL in order to obtain the Web content indicated by the URL. When receiving the access request, the network control module 254 controls the communication interface 205 to access the external site 105 via the gateway 106 and the Internet 111. The network control module 254 obtains the Web content from the external site 105 and transfers it to the browser engine 252.

The browser engine 252 transmits and receives the user data such as a cookie to and from the storage device 109 as necessary on the basis of the Web content transferred from the network control module 254, and analyzes the Web content. The browser engine 252 requests the rendering control module 253 to render the Web content in accordance with the analysis of the Web content. When receiving the request, the rendering control module 253 executes the rendering of the Web content. When the rendering is completed, the rendering control module 253 notifies the whole control module 251 of the completion. The whole control module 251 notifies the image forming apparatus 101 of the URL request source of the completion of the rendering via the network control module 254. When receiving the completion of the rendering, the image forming apparatus 101 requests to obtain the rendering result from the image generation system 100. This request is communicated to the whole control module 251 via the network control module 254 and transferred by the whole control module 251 to the rendering control module 253. Then, when receiving the request to obtain the rendering result, the rendering control module 253 transmits the rendering result to the image forming apparatus 101 that is the request source via the network control module 254. This allows the image forming apparatus 101 to display the rendering result. The user can browse the contents of the desired external site 105 on the image forming apparatus 101.

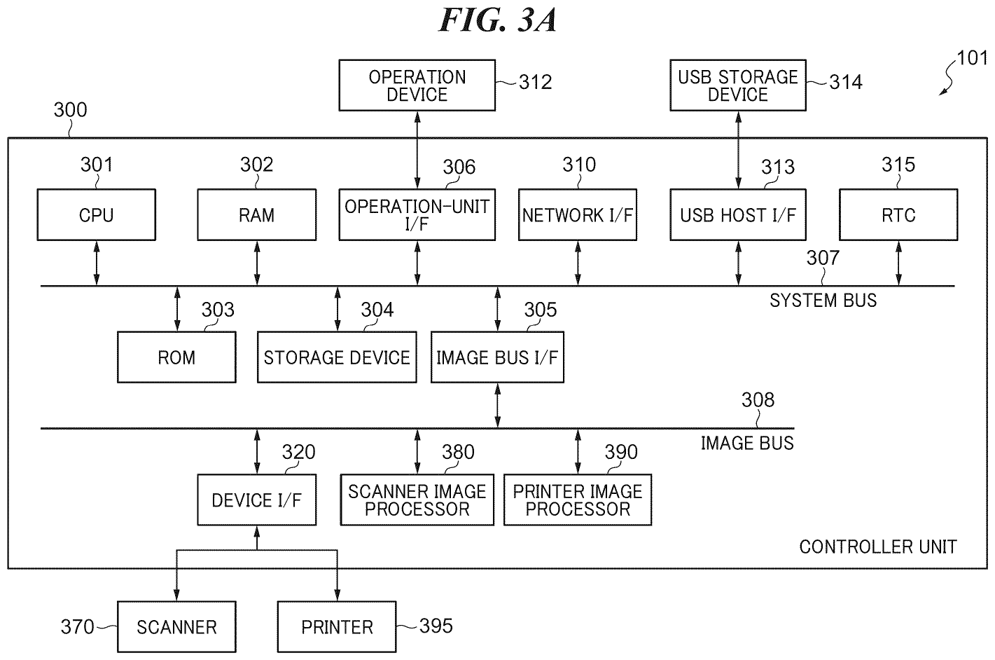

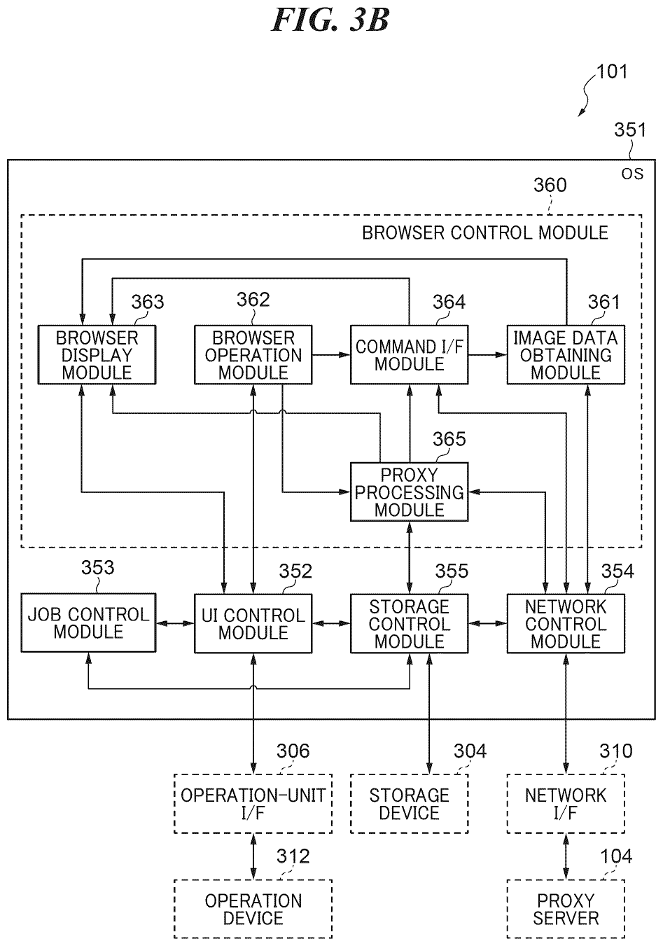

FIG. 3A is a block diagram showing an example of a hardware configuration of the image forming apparatus 101. The image forming apparatuses 102 and 103 also have the same configuration. As shown in FIG. 3A, the image forming apparatus 101 includes a controller unit 300 (controller), an operation device 312, a scanner 370, and a printer 395 as hardware. The controller unit 300 includes a CPU 301, a RAM 302, a ROM 303, a storage device (storage unit) 304, an image bus I/F 305, an operation-unit I/F 306, a network I/F 310, a USB host I/F 313, and an RTC 315. These are communicably connected to each other via a system bus 307. The controller unit 300 includes a device I/F 320, a scanner image processor 380, and a printer image processor 390. These are communicably connected to each other via an image bus 308. The system bus 307 and the image bus 308 are mutually connected via the image bus I/F 305.

The controller unit 300 controls operations of the operation device 312, the scanner 370, and the printer 395 (a control unit). For example, the controller unit 300 achieves a print function (a copy function) by controlling the scanner 370, which is an image input device, to read image data and controlling the printer 395, which is an image output device, to print out the image data. The CPU 301 starts an operating system (OS) 351 (see FIG. 3B) by a boot program stored in the ROM 303. The CPU 301 executes the program stored in the storage device 304 on the OS. The RAM 302 is used as a work area of the CPU 301. The RAM 302 provides the work area and an image memory area for temporarily storing image data. For example, programs and image data are stored in the data storage area (a storage unit) 108 of the storage device 304. The programs are not particularly limited, and for example, a control program to cause a computer to execute each unit or each means (the control method for the information processing system) of the cloud browser system 1000 is exemplified. The control program may be stored in the internal the storage device 202 of the image generation system 100, or may be distributed and stored in the storage device 304 of the image forming apparatus 101 and the internal the storage device 202 of the image generation system 100. The image data is not particularly limited, and for example, an image from the external site 105 obtained via the image generation system 100 is exemplified.

The operation device 312 is configured by a touch panel having a touch function in this embodiment. Thus, the operation device 312 can display image data from the image generation system 100 as an image (a first, second, or third image display step), for example. The touch panel may be a pressure-sensitive touch panel or an electrostatic touch panel. In the operation device 312, the user can perform a moving operation of moving an image displayed on the touch panel by dragging (scrolling) on the touch panel, that is, sliding a fingertip on the touch panel (an operation reception step). As described above, the operation device 312 in this embodiment has the function as the display unit for displaying an image and the function as the operation device capable of achieving an image moving operation by a touch function of the touch panel. In the image forming apparatus 101, a part having the function as the display unit and a part having the function as the operation device may be provided separately. The operation-unit I/F 306 is an interface that is in charge of connection with the operation device 312, and outputs the image data to the operation device 312. Thus, the operation device 312 can display the image of the image data. The operation-unit I/F 306 transmits input information (operation information) input from the user via the operation device 312 to the CPU 301.

The network I/F 310 is an interface for connecting the image forming apparatus 101 to a LAN. Accordingly, the network I/F 310 can transmit, for example, input information to the image generation system 100 (an apparatus-side transmission step). In addition, the network I/F 310 can transmit the image data obtained by the scanner 370 to an external apparatus. When the transmission of the image data is completed, the network I/F 310 can notify the image generation system 100 of transmission completion information to this effect. The network I/F 310 can also receive various kinds of information from the image generation system 100. In this way, the network I/F 310 in this embodiment has the function as the reception unit (apparatus-side reception unit) that receives various kinds of information and the function as the transmission unit (apparatus-side transmission unit) that transmits various kinds of information. In the image forming apparatus 101, a part functioning as the reception unit and a part functioning as the transmission unit may be provided separately. The USB host I/F 313 is an interface for communicating with a USB storage device 314. The USB host I/F 313 can transmit data stored in the USB storage device 314 to the CPU 301. The USB host I/F 313 also functions as an output unit to store the data stored in the storage device 304 in the USB storage device 314. The USB storage device 314 is an external storage device that stores data and is detachable from the USB host I/F 313. A plurality of USB storage devices 314 can be connected to the USB host I/F 313. The RTC 315 clocks current time. The time information clocked by the RTC 315 is used for recording job input time etc.

The image bus I/F 305 is a bus bridge for connecting the system bus 307 and the image bus 308 that transfers the image data at high speed, and converting the data format. The image bus 308 is configured by a PCI bus or the like. The scanner 370 and the printer 395 are connected to the device I/F 320. The device I/F 320 performs conversion between synchronous and asynchronous systems of the image data. The scanner image processor 380 corrects, processes, or edits the input image data, for example. The printer image processor 390 corrects print output image data or converts its resolution depending on the printer 395. As described above, the image forming apparatus 101 is an apparatus having the print function and the scan function in this embodiment, but this is not limiting, and the image forming apparatus 101 may be an apparatus having at least one of the print function, the scan function, and a facsimile function.

FIG. 3B is a block diagram showing an example of a software configuration of the image forming apparatus 101. As shown in FIG. 3B, the image forming apparatus 101 includes a browser control module 360 and a UI control module 352, a job control module 353, a network control module 354, and a storage control module 355 as software. The browser control module 360 includes an image data obtaining module 361, a browser operation module 362, a browser display module 363, a command I/F module 364, and a proxy processing module 365. Each module surrounded by a solid line in FIG. 3B is a software module achieved by the CPU 301 executing a main program loaded to the RAM 302. The main program manages and controls execution of each module by using the OS 351. The UI control module 352 displays an image (screen) on the operation device 312 and receives an operation from the user on the operation device 312 via the operation-unit I/F 306. The UI control module 352 can also control screen update by communicating with another module and receiving a rendering instruction from the other module. The job control module 353 is a module that receives a job execution instruction from the UI control module 352 and controls a job process such as copying, scanning, and printing. In this embodiment, when an operation of selecting a file is requested via the browser operation module 362, the browser operation module 362 instructs the job control module 353 to execute a scan job via the UI control module 352. The network control module 354 receives a communication request from another module and controls the network I/F 310, thereby controlling communication with an external apparatus. The network control module 354 can also receive a notification from an external apparatus and notify another module of the content of the notification. The storage control module 355 records and manages the setting information and the job information recorded in the storage device 304. Each module located in the layer of the OS 351 accesses the storage control module 355 to refer to and set a setting value.

The browser control module 360 is a sub-module contained in the OS 351. When receiving a notification of a user operation from the UI control module 352, the browser operation module 362 notifies the command I/F module 364 or the proxy processing module 365 of the content of the user operation. When receiving the notification from the browser operation module 362, the proxy processing module 365 requests to obtain proxy setting information from the storage control module 355. When it is determined that the proxy setting is valid on the basis of the proxy setting information obtained from the storage control module 355, the proxy processing module 365 transmits a communication request to the proxy server 104 via the network control module 354. The proxy processing module 365 receives a response to the communication request via the network control module 354. The proxy processing unit 365 notifies the browser display module 363 or the command I/F module 364 of the result of processing the content of the response.

When receiving the notifications from the browser operation module 362 and the proxy processing module 365, the command I/F module 364 requests communication with the image generation system 100 via the network control module 354. The communication request at this time may include the information notified from the browser the operation module 362 and the proxy processing module 365. This information also includes the information about user operations, such as text input, button press, drag, and zoom. The information about the text input includes, for example, a URL. The information about the button press includes a coordinate of a pressed position on the operation device 312. The information about the drag and zoom includes a character string associated with each operation. The command I/F module 364 receives communication from the image generation system 100 via the network control module 354. The command I/F module 364 processes the communication content from the image generation system 100 and notifies the image data obtaining module 361 or the browser display module 363 of the communication content. The image data obtaining module 361 receives a completion notification of the rendering result from the command I/F module 364. When receiving the completion notification, the image data obtaining module 361 requests to obtain an image from the image generation system 100. The image obtaining request is transmitted to the rendering control module 253 operating on the virtual machine 107 of the image generation system 100. The image is then sent out and the rendering result is sent to the image data obtaining module 361. When receiving the rendering result, the image data obtaining module 361 transfers the image as the rendering result to the browser display module 363. The browser display module 363 receives the image from the image data obtaining module 361 and instructs the UI control module 352 to draw the image. In addition, the browser display module 363 receives the notifications from the command I/F module 364 and the proxy processing module 365, and instructs the UI control module 352 to display a message corresponding to the notifications.

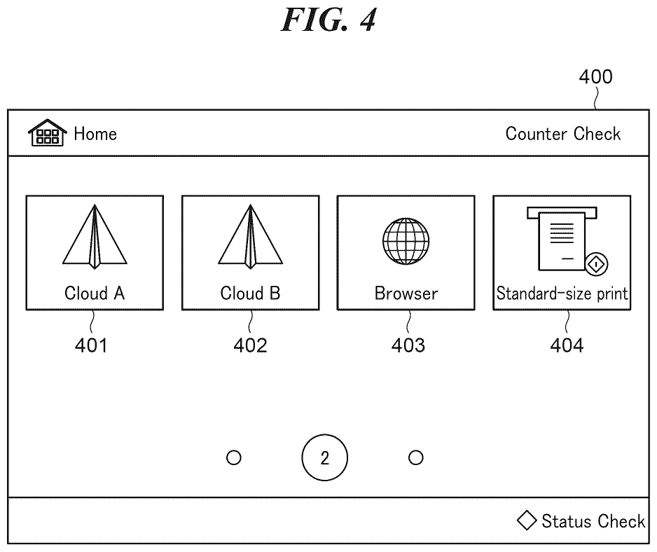

FIG. 4 is a view showing an example of a home screen displayed on the operation device of the image forming apparatus. The home screen 400 shown in FIG. 4 includes buttons 401, 402, 403, and 404. By operating, that is, pressing the button 401, for example, mail transmission to a cloud A (not shown) is enabled. By operating the button 402, for example, mail transmission to a cloud B (not shown) is enabled. By operating the button 403, the browser control module 360 is activated. By operating the button 404, the printer 395 is set in a state enabling standard-size print. As described above, the home screen 400 includes the four buttons for the user to instruct functions executable by the image forming apparatus 101. The number of the buttons included in the home screen 400 is not limited to four, and can be changed as appropriate.

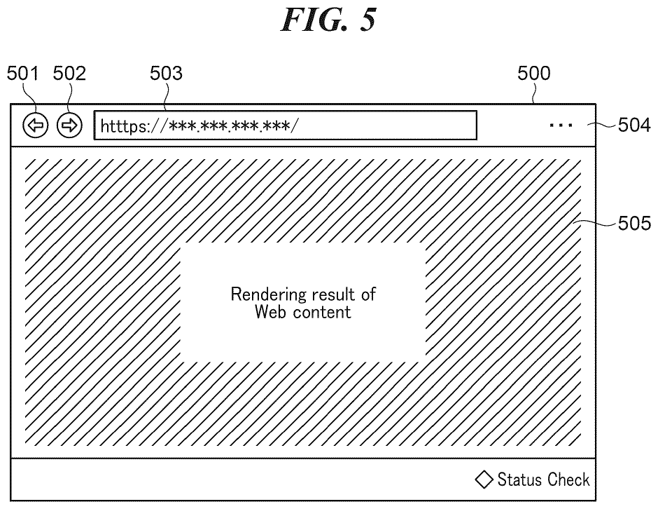

FIG. 5 is a view showing an example of a browser screen displayed on the operation device of the image forming apparatus. The browser screen 500 shown in FIG. 5 is displayed when the browser control module 360 is activated by the operation of the button 403 on the home screen 400. The browser screen 500 includes a back button 501, a forward button 502, an address bar 503, a setting button 504, and a content area 505. The browser control module 360 in the activated state can be forcibly terminated by operating a HOME key (not shown) provided in the operation device 312. The URL “https://***.***.***.***/” is displayed in the address bar 503. This URL is the address of the external site 105. In the content area 505, a result of rendering the web content obtained from the external site 105, that is, a screen of the web site is displayed. Note that the rendering result or the like is not displayed in the content area 505 until the URL is input to the address bar 503 after the browser control module 360 is activated. In addition, a default URL may be registered in an item included in the setting button 504 in the browser screen 500, and a result of rendering the Web content of the URL concerned may be displayed in the content area 505 simultaneously with the activation of the browser control module 360.

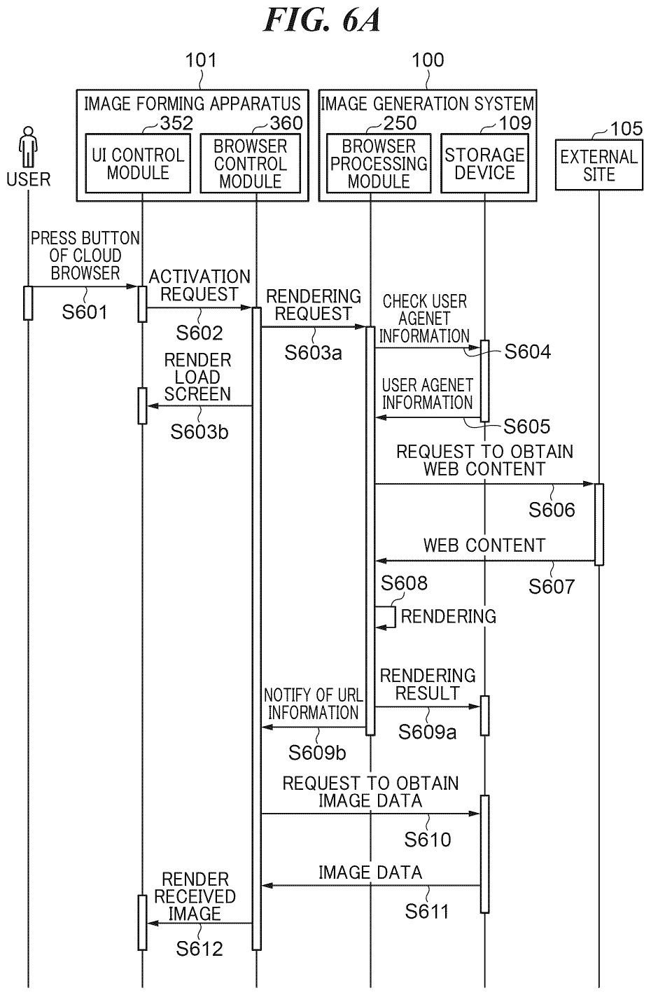

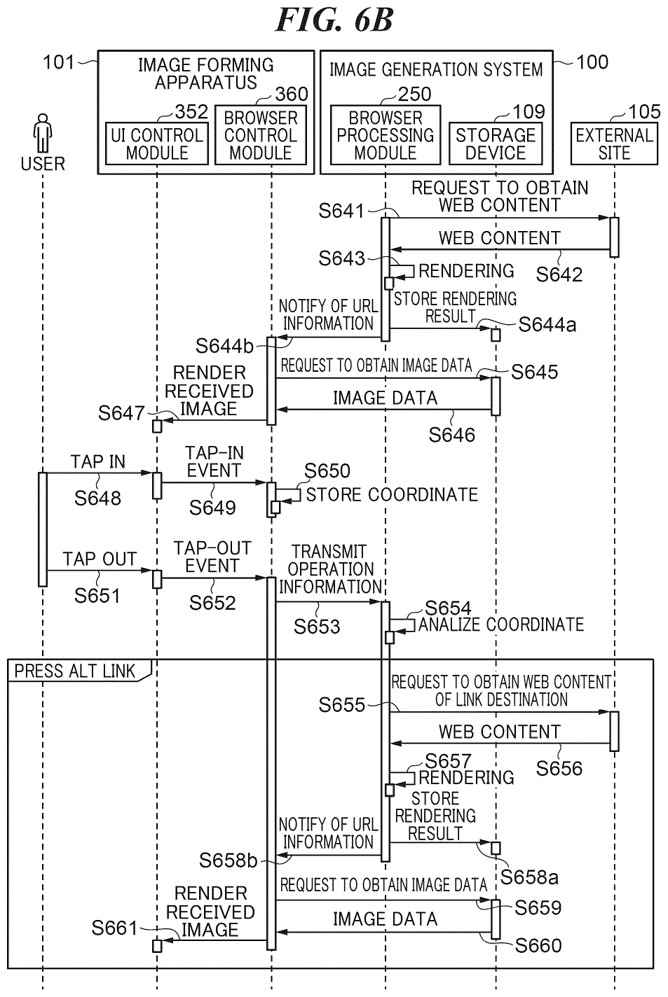

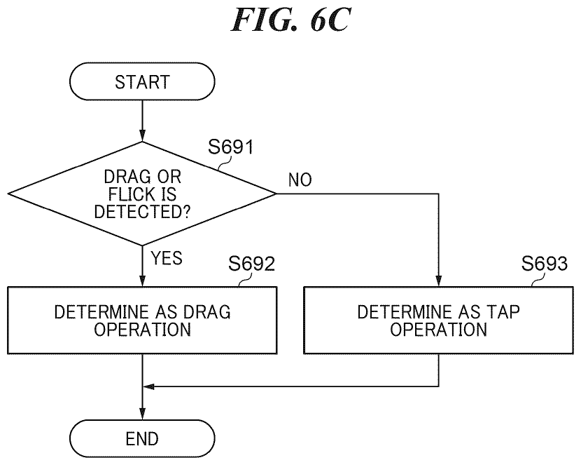

FIG. 6A is a sequential chart showing an example of a process performed between the image forming apparatus, the image generation system, and the external site. As shown in FIG. 6A, in a step S601, the user using the image forming apparatus 101 operates (presses) the button 403 on the home screen 400 (see FIG. 4) displayed on the operation device 312 of the image forming apparatus 101.

In a step S602, the UI control module 352 of the image forming apparatus 101 transmits an activation request to the browser control module 360. As a result, the browser control module 360 is activated, and the browser screen 500 (see FIG. 5) is displayed on the operation device 312 of the image forming apparatus 101.

In a step S603a, the browser control module 360 of the image forming apparatus 101 transmits a rendering request to render a web page to the browser processing module 250 (the virtual machine 107) of the image generation system 100. The rendering request includes, for example, URL information indicating the location of the Web content to be displayed on the browser screen 500, the device information of the image forming apparatus 101. The “URL information” is information about a URL set in advance as a setting value of the button 403 or information about a URL input in the address bar 503 on the browser screen 500. The “device information” is, for example, screen size information of the operation device 312 of the image forming apparatus 101 and screen type information for specifying the operation device 312, but this is not limiting.

In a step S603b, the browser control module 360 of the image forming apparatus 101 requests the UI control module 352 to display a load screen on the operation device 312, and the UI control module 352 renders the load screen. The load screen is a screen for notifying the user that the process is in progress until the browser screen 500 is displayed. The notification screen is not limited to the load screen, and may be, for example, a pop-up screen.

When receiving the rendering request in the step S603a, the browser processing module 250 checks presence or absence of user agent information stored in the storage device 109 on the basis of the device information in the rendering request in a step S604.

When the user agent information exists in the storage device 109, the browser processing module 250 obtains the user agent information from the storage device 109 in a step S605.

In a step S606, the browser processing module 250 requests to obtain the Web content from the external site 105 on the basis of the URL information obtained in response to the rendering request in the step S603a and the user agent information obtained in the step S605.

In a step S607, the browser processing module 250 receives the Web content from the external site 105 as a response to the request to obtain the Web content in the step S606.

In step S608, the browser processing module 250 renders the web content received in the step S607.

In a step S609a, the browser processing module 250 stores the results of the rendering performed in the step S608 in the storage device 109.

In a step S609b, the browser processing module 250 notifies the browser control module 360 included in the image forming apparatus 101 of the URL information indicating the location of the image data of the rendering result stored in the step S609a.

In a step S610, the browser control module 360 of the image forming apparatus 101 requests to obtain the image data from the storage device 109 of the image generation system 100 on the basis of the URL information notified in the step S609b. This request is performed using the URL information notified in the step S609b.

In a step S611, the browser control module 360 receives the image data from the storage device 109 as a result of the request to obtain the image data in the step S610.

In a step S612, the browser control module 360 instructs the UI control module 352 to display the image data received in the step S611 in the content area 505 on the browser screen 500. As a result, the browser screen 500 including the image of the content area 505 suitable for the size of the operation device 312, that is, the screen size of the touch panel is displayed on the operation device 312 of the image forming apparatus 101.

FIG. 6B is a sequential chart showing an example of a process performed between the image forming apparatus, the image generation system, and the external site. As shown in FIG. 6B, in a step S641, the browser processing module 250 of the image generation system 100 requests to obtain a Web content from the external site 105 as with the process in the step S606 in FIG. 6A.

In a step S642, the browser processing module 250 receives the web content from the external site 105 as a response to the request to obtain a Web content in the step S641 as with the process in the step S607 in FIG. 6A.

In a step S643, the browser processing module 250 renders the web content as with the process in the step S608 in FIG. 6A.

In a step S644a, the browser processing module 250 stores (saves) the result of the rendering performed in the step S643 in the storage device 109 as with the process in the step S609a in FIG. 6A.

In a step S644b, the browser processing module 250 notifies the browser control module 360 included in the image forming apparatus 101 of the URL information indicating the location of the image data of the rendering result stored in the step S644a as with the process in the step S609b in FIG. 6A.

In a step S645, the browser control module 360 of the image forming apparatus 101 requests to obtain the image data from the storage device 109 of the image generation system 100 as with the process in the step S610 in FIG. 6A.

In a step S646, the browser control module 360 receives the image data from the storage device 109 as a result of the image data obtaining request in the step S645 as with the process in the step S611 in FIG. 6A.

In a step S647, the browser control module 360 instructs the UI control module 352 to render the image data received in the step S646. Thus, the image of the image data is displayed (rendered) on the operation device 312.

In a step S648, the user performs tap-in (a tap-in operation) on the image displayed on the operation device 312 in the step S647. The “tap-in” is an operation in which the user touches or presses the touch panel with a fingertip or the like. Then, the operation device 312 transmits an electric signal corresponding to the position of the fingertip (tap-in) on the touch panel to the UI control module 352 (CPU 301). Thus, the UI control module 352 can specify the coordinate of the position of the fingertip on the basis of the electric signal.

In a step S649, the UI control module 352 of the image forming apparatus 101 transmits the information about the coordinate specified in the step S648 to the browser control module 360 as a tap-in event.

In a step S648, the user can also perform a drag by sliding the fingertip on the touch panel, for example, to up, down, right, or left after the tap-in. In this case, the electric signal also varies in accordance with the change in the position of the fingertip on the touch panel. Thus, the UI control module 352 can specify the coordinate that varies in accordance with the movement of the fingertip on the basis of the electric signal at each predetermined time interval. Then, in a step S649, the UI control module 352 transmits the information about the coordinate that varies in accordance with the movement of the fingertip and the information about the moving amount of the fingertip to the browser control module 360 as a drag event.

In a step S650, the browser control module 360 stores the information transmitted from the UI control module 352 in the step S649 in the RAM 302.

In a step S651, the user performs a tap-out (tap-out operation) on the image displayed on the operation device 312 in the step S647. The “tap-out” refers to an operation of releasing the fingertip from the position where the user touches the touch panel by the tap-in or the drag. Then, an electric signal corresponding to a position where the fingertip is separated from the touch panel (tap-out) is transmitted from the operation device 312 to the UI control module 352. Thus, the UI control module 352 can specify the coordinate of the position where the fingertip is separated on the basis of the electric signal.

In a step S652, the UI control module 352 of the image forming apparatus 101 transmits information about the coordinate identified in the step S651 to the browser control module 360 as a tap-out event. Note that an operation of performing a tap-in, then sliding the fingertip on the touch panel more quickly than a normal drag, and then performing a touch-out is referred to as a “flick”. Further, the flick operation may be divided into the drag and the tap-out. In this case, the process at the time of the drag and the process at the time of tap-out are executed. This enables image movement (scrolling) by the flick. The UI control module 352 can transmit information about the coordinate of the flick to the browser control module 360 as a flick event as with the tap-out event and the drag event.

The browser control module 360 determines whether the operation performed by the user in the steps S648 to S651 is an operation including a drag (flick). This determination will be described with reference to FIG. 6C.

FIG. 6C is a flowchart showing a process (drag operation determination process) executed in the image forming apparatus. As shown in FIG. 6C, in a step S691, the browser control module 360 determines whether a drag or a flick has been performed (is detected). This determination is executed based on whether the coordinate of the tap-in event transmitted in the step S649 is the same as the coordinate of the tap-out event transmitted in the step S652. Specifically, when the coordinates of the two are different from each other, it is determined that the drag has been performed, and when the coordinates of the two are the same to each other, it is determined that the drag has not been performed. Then, as a result of the determination in the step S691, when it is determined that the drag is performed, the process proceeds to a step S692. On the other hand, if it is determined in the step S691 that no drag has been performed, the process proceeds to a step S693.

In the step S692, the browser control module 360 determines that the operation performed by the user in the steps S648 to S651 is a drag operation.

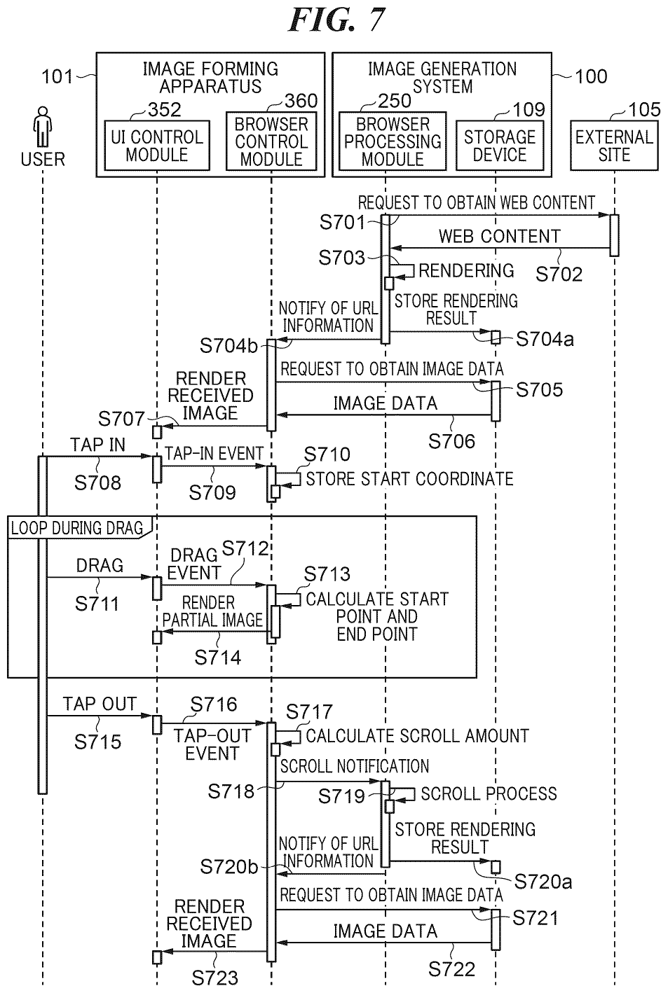

In the step S693, the browser control module 360 determines that the operation performed by the user in the steps S648 to S651 is a tap operation, i.e., a simple press operation. Note that, here, as an example, it is assumed that the operation is determined to be a tap operation. The case where the operation is determined to include a drag will be described later with reference to FIG. 7.

Then, in a step S653, the browser control module 360 transmits the start coordinate of the tap operation, that is the information about the coordinate at the time of the tap-in, to the browser processing module 250 of the image generation system 100 as operation information.

In a step S654, the browser processing module 250 analyzes the presence or absence of a URL of a link destination at the coordinate, the presence or absence of an input field for a text or the like on the basis of the coordinate information transmitted in the step S653. In this example, it is assumed that the URL of the link destination is present as an analysis result.

In a step S655, the browser processing module 250 requests to obtain the URL of the link destination from the external site 105 as the analysis result in the step S654, that is, the Web content.

In a step S656, the browser processing module 250 receives the web content from the external site 105 as a response to the request to obtain the web content in the step S655.

In a step S657, the browser processing module 250 renders the web content received in the step S656.

In a step S658a, the browser processing module 250 stores the results of the rendering performed in the step S657 in the storage device 109.

In a step S658b, the browser processing module 250 notifies the browser control module 360 included in the image forming apparatus 101 of the URL information indicating the location of the image data of the rendering result stored in the step S658a.

In a step S659, the browser control module 360 of the image forming apparatus 101 requests to obtain image data from the storage device 109 of the image generation system 100 on the basis of the URL information notified in the step S658b.

In a step S660, the browser control module 360 receives the image data from the storage device 109 as a result of the request to obtain the image data in the step S659.

In a step S661, the browser control module 360 instructs the UI control module 352 to render the image data received in the step S660. As a result, the image of the link destination analyzed in the step S654 is displayed on the operation device 312.

FIG. 7 is a sequential chart showing an example of a process executed between the image forming apparatus, the image generation system, and the external site. As shown in FIG. 7, in a step S701, the browser processing module 250 of the image generation system 100 requests to obtain the Web content from the external site 105 as with the process in the step S606 in FIG. 6A.

In a step S702, the browser processing module 250 receives the web content from the external site 105 as a response to the web content obtaining request in the step S701 as with the process in the step S607 in FIG. 6A.

In step S703, the browser processing module 250 renders the web content as with the process in the step S608 in FIG. 6A.

In a step S704a, the browser processing module 250 stores the result of the rendering performed in the step S703 in the storage device 109 as with the process in the step S609a in FIG. 6A.

In a step S704b, the browser processing module 250 notifies the browser control module 360 included in the image forming apparatus 101 of the URL information indicating the location of the image data of the rendering result stored in the step S704a as with the process in the step S609b in FIG. 6A.

In a step S705, the browser control module 360 of the image forming apparatus 101 requests to obtain the image data from the storage device 109 of the image generation system 100 as with the process in the step S610 in FIG. 6A.

In a step S706, the browser control module 360 receives the image data from the storage device 109 as a result of the image data obtaining request in the step S705 as with the process in the step S611 in FIG. 6A.

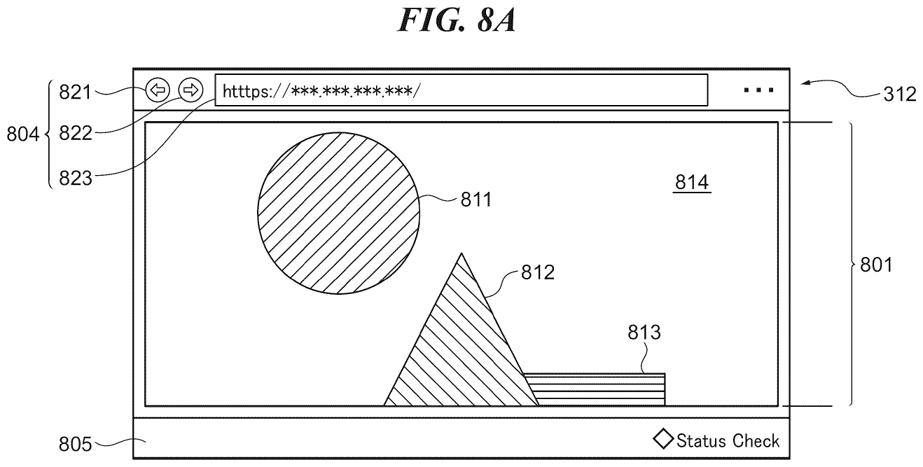

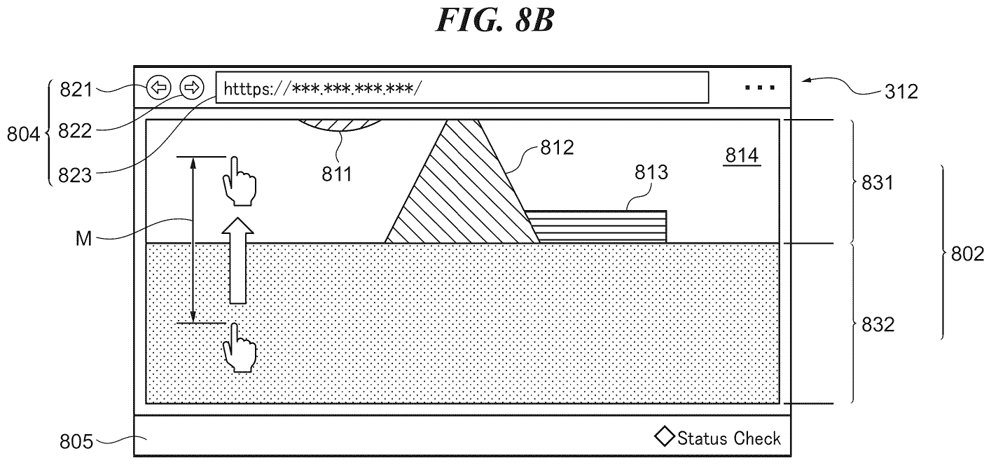

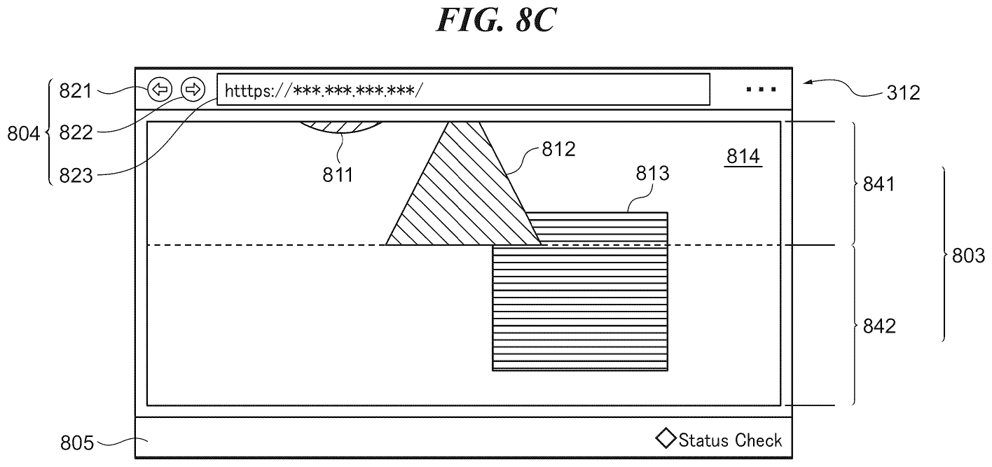

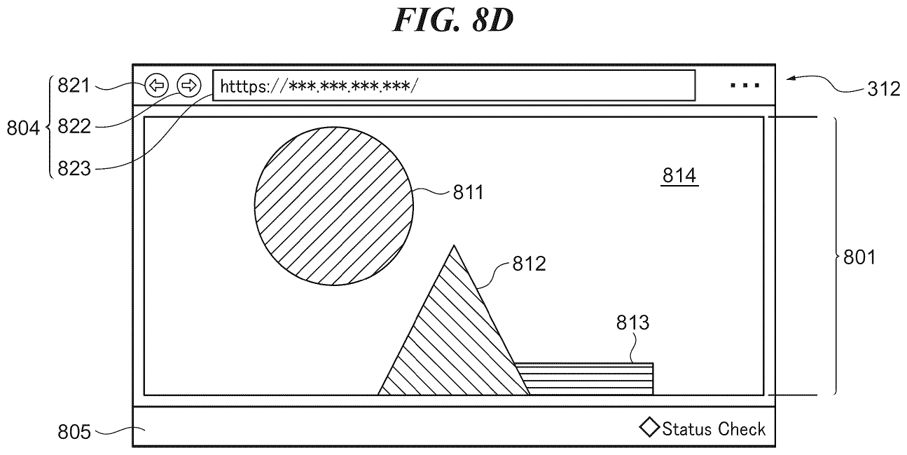

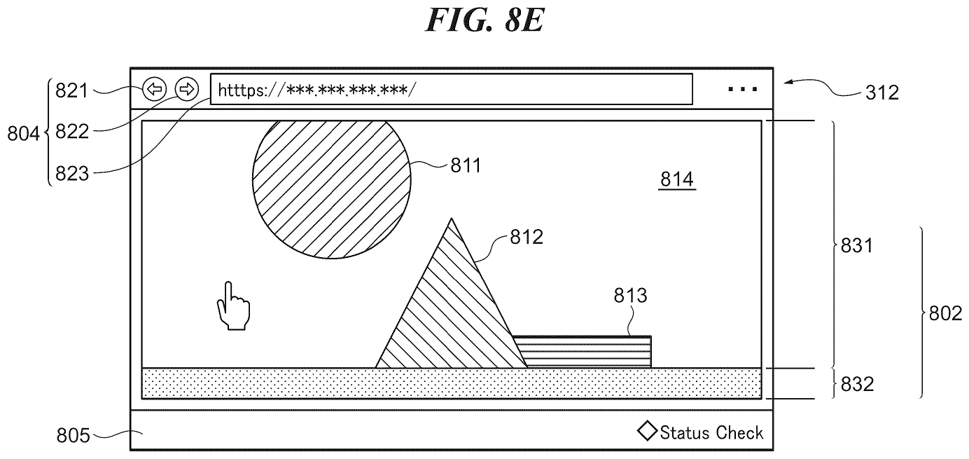

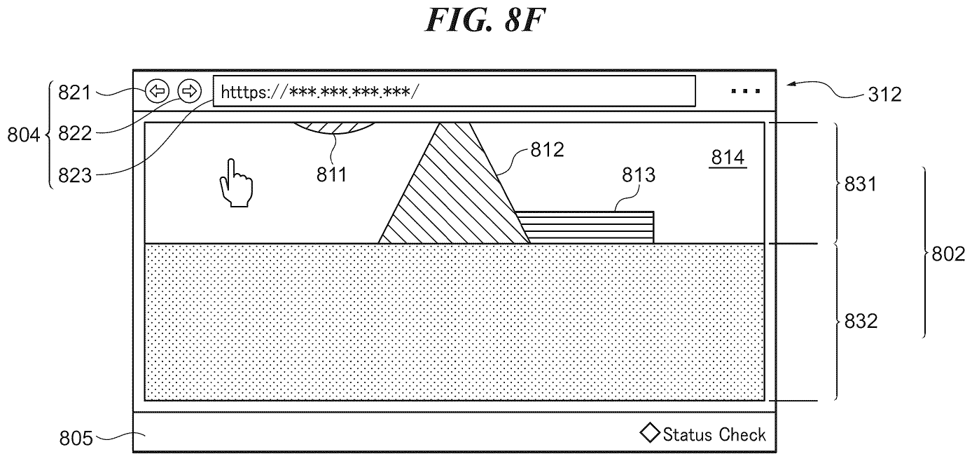

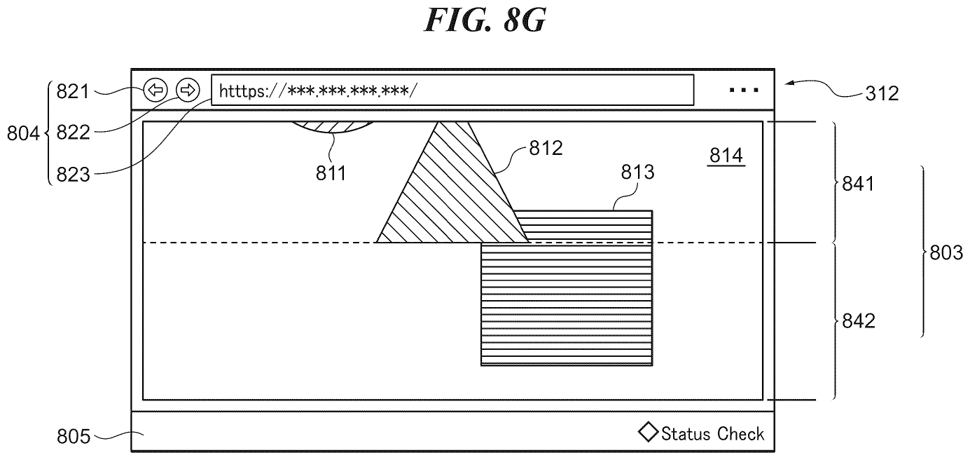

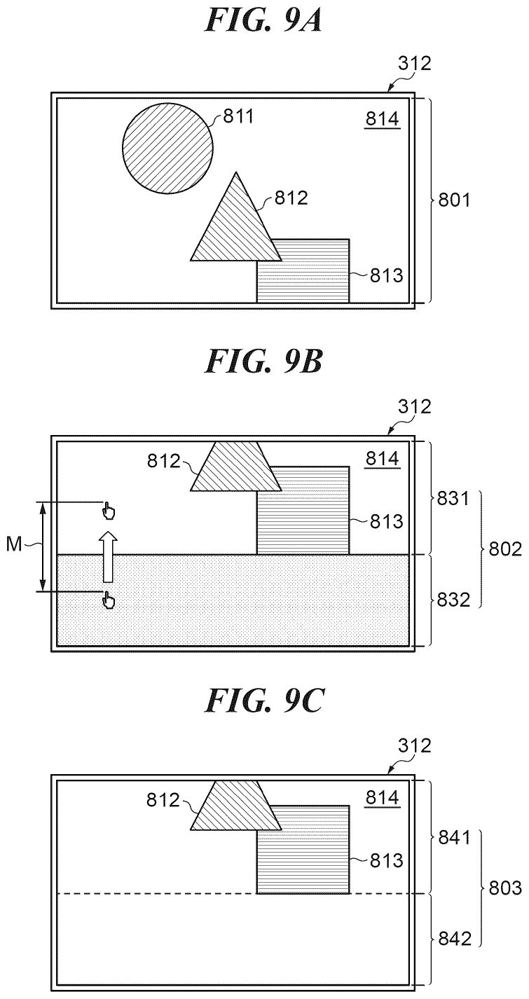

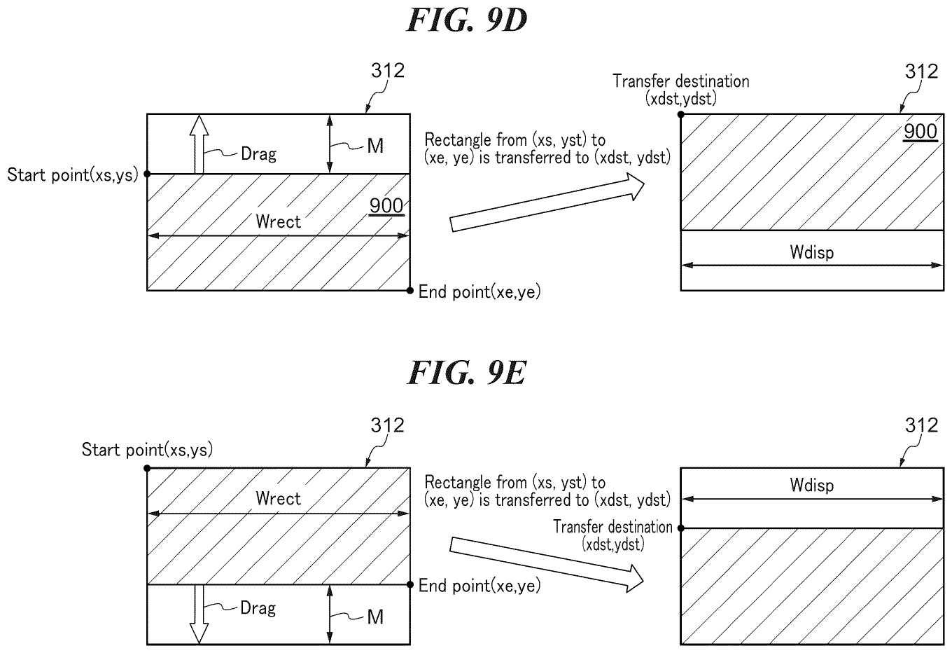

In a step S707, the browser control module 360 instructs the UI control module 352 to render the image data received in step S706. As a result, the image of the image data is displayed on the operation device 312. For example, an image shown in FIG. 8A, FIG. 8D, or FIG. 9A is displayed here. Each image will be described later.

In a step S708, the user performs the tap-in operation on the image displayed on the operation device 312 in the step S707. Then, an electric signal corresponding to the tap-in is transmitted from the operation device 312 to the UI control module 352. Thus, the UI control module 352 can specify the coordinate of the position of the fingertip on the basis of the electric signal.

In a step S709, the UI control module 352 of the image forming apparatus 101 transmits the information about the coordinate specified in the step S708 to the browser control module 360 as a tap-in event.

In a step S710, the browser control module 360 stores the information (coordinate of the tap-in position) transmitted from the UI control module 352 in the step S709 in the RAM 302.

In a step S711, the user performs a drag by sliding the fingertip that taps in the image in the step S708 on the touch panel as-is. Then, an electric signal that varies in accordance with the drag is transmitted from the operation device 312 to the UI control module 352. Thus, the UI control module 352 can specify the coordinate that varies in accordance with the movement of the fingertip on the basis of the electric signal.

In a step S712, the UI control module 352 transmits the information about the coordinate that is specified in the step S711 and is varying with the movement of the fingertip to the browser control module 360 as a drag event.

In a step S713, the browser control module 360 calculates the coordinate of the start point and the coordinate of the end point in the drag operation on the basis of the information transmitted from the UI control module 352 in the step S712. The coordinate of the start point is the same as the coordinate of the tap-in position in the step S708. The calculation result by the browser control module 360 is stored in the RAM 302.

In a step S714, the browser control module 360 instructs the UI control module 352 to render the image data on the basis of the coordinate of the start point and the coordinate of the end point calculated in the step S713. Thus, a partial image of the image data is displayed on the operation device 312. For example, a partial image shown in FIG. 8B, FIG. 8E, FIG. 8F, or FIG. 9B is displayed here. Each image will be described later.

In a step S715, the user performs a tap-out of releasing the fingertip from the image on which the drag is performed in the step S711. Then, an electric signal corresponding to the position of the tap-out is transmitted from the operation device 312 to the UI control module 352. Thus, the UI control module 352 can specify the coordinate of the position where the fingertip is separated on the basis of the electric signal. The coordinate of the position where the fingertip is separated is the same as the coordinate of the end point calculated in the step S713.

In a step S716, the UI control module 352 of the image forming apparatus 101 transmits the information about the coordinate specified in the step S715 to the browser control module 360 as a tap-out event.

Next, the browser control module 360 determines whether the operation performed by the user in the steps S708 to S715 is an operation including a drag. Note that, here, as an example, it is assumed that the operation is determined to include a drag. Then, the browser control module 360 calculates the moving amount of the fingertip (the amount of scroll of the image) at the time of the drag in a step S717 on the basis of the coordinate of the start point and the coordinate of the end point calculated in the step S713, for example. Specifically, the browser control module 360 calculates the distance between the coordinate of the start point and the coordinate of the end point as the moving amount of the fingertip. In the step S717, the browser control module 360 may calculate the difference between the coordinate of the tap-in position stored in the step S710 and the coordinate of the tap-out or flick position, and determine whether the difference is more than a predetermined threshold. Thus, when the moving amount due to the drag is small, scrolling of the image can be suppressed.

In a step S718, the browser control module 360 transmits the information about the moving amount calculated in the step S717 to the browser processing module 250 of the image generation system 100.

In a step S719, the browser processing module 250 performs a scroll process. The scroll process is achieved by the browser processing module 250 that links an operation amount (a rotation amount) of a mouse wheel to the moving amount of the image. The browser processing module 250 executes a process to generate the image data based on the moving amount transmitted in the step S718.

In a step S720a, the browser processing module 250 stores the image data generated in the step S719 in the storage device 109.

In a step S720b, the browser processing module 250 notifies the browser control module 360 included in the image forming apparatus 101 of the URL information indicating the location of the image data stored in the step S720a.

In a step S721, the browser control module 360 of the image forming apparatus 101 requests to obtain the image data from the storage device 109 of the image generation system 100 on the basis of the URL information notified in the step S720b.

In a step S722, the browser control module 360 receives the image data from the storage device 109 as a result of the request to obtain the image data in the step S721. The image data is the data stored in the step S720a.

In a step S723, the browser control module 360 instructs the UI control module 352 to render the image data received in the step S722. As a result, the image of the image data is displayed on the operation device 312. For example, an image shown in FIG. 8C, FIG. 8G, or FIG. 9C is displayed here. Each image will be described later.

FIGS. 8A to 8C are views showing examples of images displayed on the operation device of the image forming apparatus. As described above, in the image forming apparatus 101, the user can perform a moving operation to move the image displayed on the touch panel (hereinafter, referred to as an “image moving operation”) by the drag on the operation device 312 (on the touch panel). FIG. 8A shows an image displayed before the moving operation. FIG. 8B shows an image displayed during the moving operation. FIG. 8C shows an image displayed after the moving operation. Note that an image displayed at each timing is not limited to the image shown in the drawing. The controller unit 300 performs image display control for displaying an image.

In a state shown in FIG. 8A, a first image 801, a first information image 804, and a second information image 805 are displayed on the operation device 312. The first image 801 is an image that can be dragged and is a result of rendering by the browser processing module 250 of the image generation system 100. The first image 801 includes a first object 811 having a circular shape, a second object 812 having a triangular shape, and a third object 813 having a quadrangular shape. In the first image 801, the positional relationship between the first object 811 to the third object 813 is fixed. A background 814 of the first image 801 is mainly white. The first information image 804 and the second information image 805 are both images whose display positions are maintained even when the first image 801 is dragged. The first information image 804 includes a forward button 821 operated to advance a displayed image to a next image, a back button 822 operated to return a displayed image to a previously displayed image, and an address bar 823 indicating a URL of a link destination of an image. A comment “Status Check” is displayed in the second information image 805.

In a state shown in FIG. 8B, a second image 802, the first information image 804, and the second information image 805 are displayed on the operation device 312. The second image 802 includes a moved image 831 and a blank image 832. The second image 802 is generated by the browser control module 360 of the image forming apparatus 101. The moved image 831 is an image indicating a state in which the first image 801 is moved by the moving amount M due to the moving operation applied to the first image 801 by an upward drag. The moved image 831 includes the first object 811 whose size is reduced by the moving amount M, the second object 812 whose size is reduced by the moving amount M, and the third object 813 whose size is not changed. The background 814 is white as-is. The blank image 832 is an image that becomes blank for the moving amount M in accordance with the movement of the first image 801. When generating the second image 802, the browser control module 360 fills the blank image 832 with a color (for example, gray) different from the color (white) of the background 814. When the moving operation of the first image 801 is performed, the second image 802 as described above is displayed. Then, the user can quickly grasp the moving amount M by the moving operation by checking the blank image 832 included in the second image 802. In the image forming apparatus 101, when the moving operation to the first image 801 is finished, the operation information regarding the moving amount M is transmitted to the image generation system 100. On the other hand, the image generation system 100 receives the operation information from the image forming apparatus 101. This enables the image generation system 100 to generate a third image 803.

In a state shown in FIG. 8C, the third image 803, the first information image 804, and the second information image 805 are displayed on the operation device 312. The third image 803 is an image as a result of rendering by the browser processing module 250 of the image generation system 100, that is, a changed image in a state where the first image 801 is changed in accordance with the image moving operation. In this way, the browser processing module 250 functions as a generation unit that generates the image data of the third image 803 (generation step). The image data of the third image 803 is transmitted to the image forming apparatus 101. Thus, in the image forming apparatus 101, after the second image 802 is displayed, the second image 802 can be replaced with the third image 803. The third image 803 includes a corresponding image 841 corresponding to (equivalent to) the moved image 831 and an auxiliary image 842 that is continuously connected to the corresponding image 841 (moving image 831) and fills the blank image 832. The corresponding image 841 includes the first object 811 whose size is reduced by the moving amount M, the second object 812 whose size is reduced by the moving amount M, and the third object 813 as with the moved image 831. The auxiliary image 842 compensates for the size of the third object 813 by the moving amount M. The background 814 of the third image 803 is white as-is. Note that a broken line at the boundary between the corresponding image 841 and the auxiliary image 842 in the third image 803 is for ease of understanding, and is not actually displayed. Then, the first image 801, the second image 802, and the third image 803 are displayed sequentially as described above, and thus the user can feel that the image has smoothly moved, that is, transitioned from the first image 801 to the third image 803.

FIGS. 8D to 8G are views showing examples of images displayed on the operation device of the image forming apparatus. FIG. 8D shows an image displayed before the moving operation. FIGS. 8E and 8F show images displayed during the moving operation. FIG. 8G shows an image displayed after the moving operation. Hereinafter, differences from FIGS. 8A to 8C will be mainly described, and the descriptions of the same matters will be omitted. In a state shown in FIG. 8D, the first image 801, the first information image 804, and the second information image 805 are displayed on the operation device 312. In states shown in FIGS. 8E and 8F, the second image 802, the first information image 804, and the second information image 805 are displayed on the operation device 312. The second image 802 includes the moved image 831 and the blank image 832. In the second image 802, the display area of the moved image 831 and the display area of the blank image 832 respectively vary in conjunction with the image moving operation. Specifically, in conjunction with the image moving operation, the display area of the moved image 831 gradually narrows, and the display area of the blank image 832 gradually widens accordingly. By checking the blank image 832, the user can grasp the degree of the moving amount M at the present time when the image moving operation is performed. In a state shown in FIG. 8G, the third image 803, the first information image 804, and the second information image 805 are displayed on the operation device 312.

FIGS. 9A to 9C are views showing examples of images displayed on the operation device of the image forming apparatus. FIG. 9A shows an image displayed before the moving operation. FIG. 9B shows an image displayed during the moving operation. FIG. 9C shows an image displayed after the moving operation. Hereinafter, differences from FIGS. 8A to 8C will be mainly described, and the descriptions of the same matters will be omitted. In a state shown in FIG. 9A, the first image 801 is displayed on the operation device 312. In a state shown in FIG. 9B, the second image 802 is displayed on the operation device 312. In a state shown in FIG. 9C, the third image 803 is displayed on the operation device 312. In this way, the images excluding the first information image 804 and the second information image 805 shown in FIGS. 8A to 8C are displayed on the operation device 312. Thus, the entire image displayed on the operation device 312 can be dragged.

FIGS. 9D and 9E are views for describing a start point and an end point of an image moved by a drag. FIG. 9D is a view showing a start point and an end point of an image moved by an upward drag. FIG. 9E is a view showing a start point and an end point of an image moved by a downward drag. As shown in the left side in FIG. 9D, it is assumed that the user drags upward by the moving amount M on the operation device 312 (touch panel). In this case, a rectangular area 900 (a hatched part in FIG. 9D) from a start point (xs, ys) to an end point (xe, ye) is transferred to a position where the start point overlaps a transfer destination (xdst, ydst) as shown in the right side in FIG. 9D. By this transfer, the rectangular area 900 is visually recognized as if it has moved upward by the moving amount M. Note that the rectangular area 900 in the left side in FIG. 9D corresponds to the image data received by a reception memory. The rectangular area 900 in the right side in FIG. 9D corresponds to the image data received by the reception memory and transferred to an image memory. A width Wrect of the rectangular area 900 is obtained by (xe-xs) and is the same as a width Wdisp of the touch panel.

As shown in the left side in FIG. 9E, it is assumed that the user drags downward by the moving amount M on the operation device 312. In this case, a rectangular area 900 (a hatched part in FIG. 9E) from a start point (xs, ys) to an end point (xe, ye) is transferred to a position where the start point overlaps a transfer destination (xdst, ydst) as shown in the right side in FIG. 9E. By this transfer, the rectangular area 900 is visually recognized as if it has moved downward by the moving amount M. Note that the rectangular area 900 in the left side in FIG. 9E corresponds to the image data received by the reception memory. The rectangular area 900 in the right side in FIG. 9E corresponds to the image data received by the reception memory and transferred to the image memory.

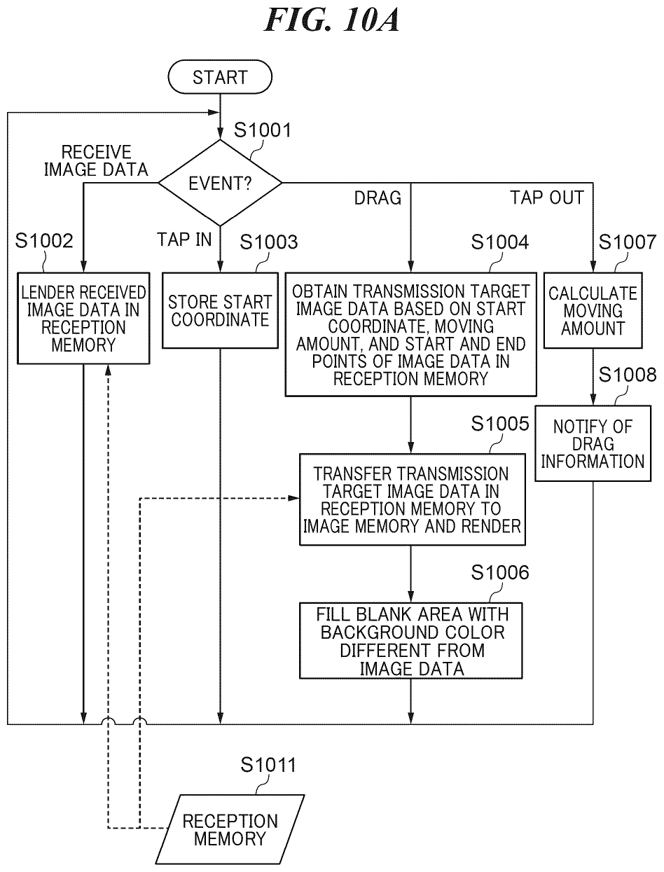

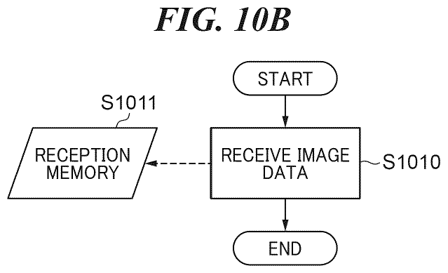

FIGS. 10A and 10B are flowcharts showing processes executed by the image forming apparatus (the browser control module). FIG. 10A is a flowchart showing a drag-and-rendering process executed by the browser display module 363 of the browser control module 360. FIG. 10B is a flowchart showing an image data reception process executed by the image data obtaining module 361 of the browser control module 360. The processes are executed independently. As shown in FIG. 10A, in a step S1001, the browser control module 360 (the browser display module 363) of the image forming apparatus 101 determines the type of the event such as reception of image data or an operation (tap-in, drag, tap-out) by the user. This determination is based on a content of a message in a format defined between the modules. As a result of the determination in the step S1001, when the event is determined as the reception of the image data, the process proceeds to a step S1002. As a result of the determination in the step S1001, when the event is determined as the tap-in, the process proceeds to a step S1003. As a result of the determination in the step S1001, when the event is determined as the drag, the process proceeds to a step S1004. As a result of the determination in the step S1001, when the event is determined as the tap-out, the process proceeds to a step S1007.

In the step S1002, the browser control module 360 transfers the image data received in the reception memory to the image memory, and causes the UI control module 352 to render the data in the image memory. The reception memory is assigned to the RAM 302 (see FIG. 3A) and the image data is input in a step S1011. Broken lines in FIG. 10A indicate that the image data is being read from the reception memory. The image memory is also assigned to the RAM 302 as with the reception memory. After the execution of the step S1002, the process returns to the step S1001, and the subsequent steps are sequentially executed.

In the step S1003, the browser control module 360 stores the coordinate tapped in on the operation device 312 (a start coordinate) in the RAM 302. After the execution of the step S1003, the process returns to the step S1001, and the subsequent steps are sequentially executed.

In the step S1004, the browser control module 360 obtains data of a transmission target image (the rectangular area 900) on the basis of the start coordinate stored in the step S1003, the moving amount M, and the start point and the end point of the image data in the reception memory. The method of obtaining the data is not particularly limited, and for example, the method described with reference to FIG. 9D and FIG. 9E can be used. Note that the moving amount M is the difference between the coordinate stored in the step S1003 and the coordinate of the drag event. After the execution of the step S1004, the process proceeds to a step S1005.

In the step S1005, the browser control module 360 transfers data of the transmission target image (the rectangular area 900) on the reception memory obtained in the step S1004 to the image memory, and causes the UI control module 352 to render the data in the image memory. After the execution of the step S1005, the process proceeds to a step S1006.

In the step S1006, the browser control module 360 transfers data of a background of a different color from the moved image (image data) to an area to be a blank image in the image memory, and causes the UI control module 352 to render the blank image. The different color of the background is not particularly limited, and for example, the different color of the background may be a color obtained by reversing the original color of the area to be the blank image, or may be predetermined hatching. After the execution of the step S1006, the process returns to the step S1001, and the subsequent steps are sequentially executed.

In the step S1007, the browser control module 360 calculates the moving amount M on the basis of the coordinate of the tap-in and the coordinate of the tap-out. The moving amount M includes an up-down component that is a moving direction of the image in this embodiment, but this is not limiting. For example, when the object is moved in a left-right direction, the moving amount M may include a component in the left-right direction or may include only a component having a larger value among the component in the up-down direction and the component in the left-right direction. After the execution of the step S1007, the process proceeds to a step S1008.

In the step S1008, the browser control module 360 notifies the browser processing module 250 included in the image generation system 100 of drag information. The drag information includes the start coordinate stored in the step S1003 and the moving amount M obtained in the step S1007. After the execution of the step S1008, the process returns to the step S1001, and the subsequent steps are sequentially executed.

As shown in FIG. 10B, in a step S1010, the browser control module 360 (the image data obtaining module 361) of the image forming apparatus 101 receives the image data. Then, in a step S1011, the browser control module 360 inputs the image data received in the step S1010 to the reception memory. As a result, the image data is stored in the reception memory. A broken line in FIG. 10B indicates that the image data is input to the reception memory.

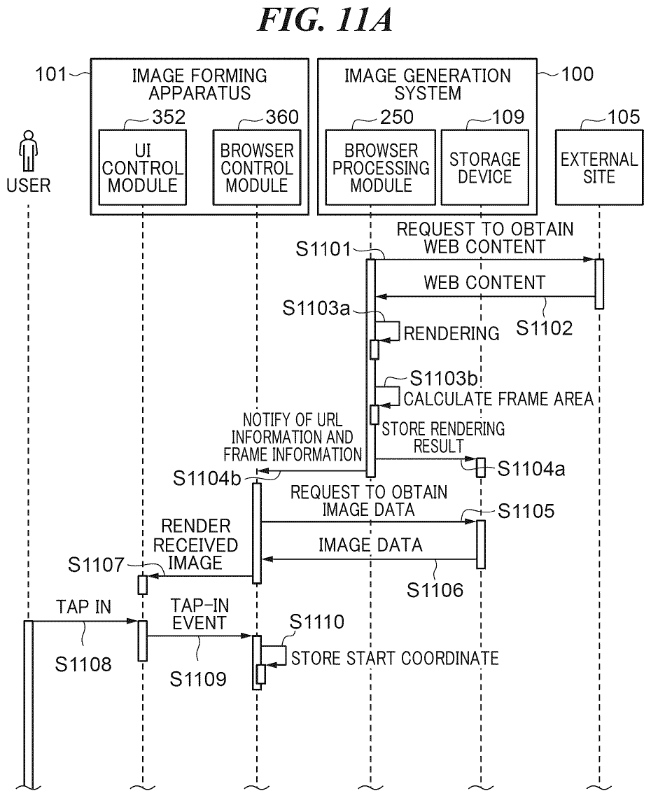

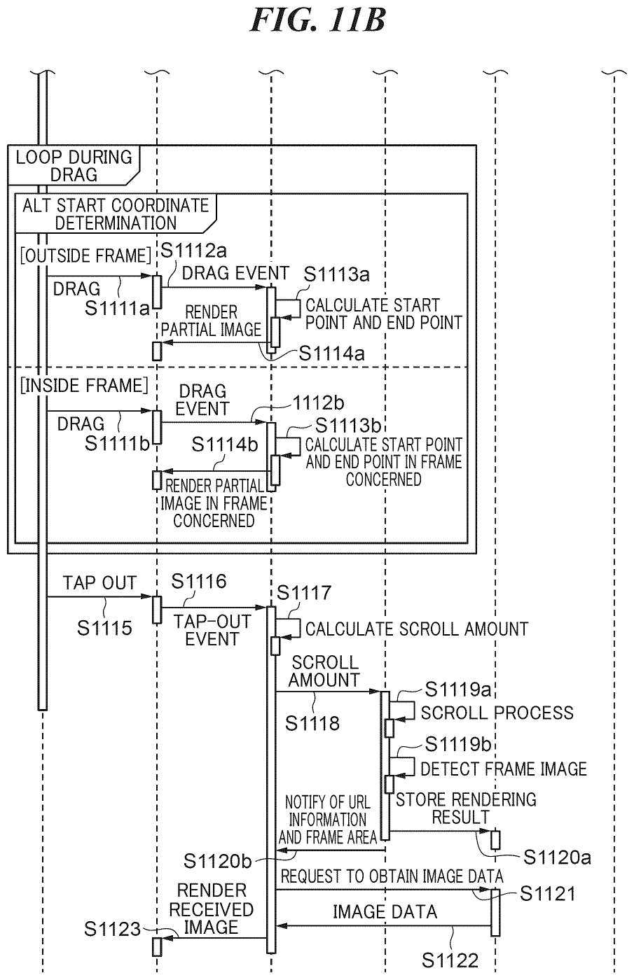

Hereinafter, a second embodiment will be described with reference to FIGS. 11A to 15, but differences from the above-described embodiment will be mainly described and descriptions of the same matters will be omitted. This embodiment is the same as the first embodiment except that an image that can be dragged (hereinafter, may be referred to as a “draggable image”) contains a small image that can be dragged (hereinafter, may be referred to as a “frame image”). FIGS. 11A and 11B are sequential charts showing an example of a process executed between an image forming apparatus and an image generation system of a cloud browser system according to the second embodiment, and an external site. As shown in FIG. 11A, in a step S1101, the browser processing module 250 of the image generation system 100 requests to obtain a Web content from the external site 105.

In a step S1102, the browser processing module 250 receives the web content from the external site 105 as a response to the request to obtain the web content in the step S1101.

In a step S1103a, the browser processing module 250 renders the web content received in the step S1102.

In a step S1103b, the browser processing module 250 detects a frame image included in a draggable image as a result of the rendering in the step S1103a (calculates a frame area).

In a step S1104a, the browser processing module 250 stores the result of the rendering performed in the step S1103a in the storage device 109.

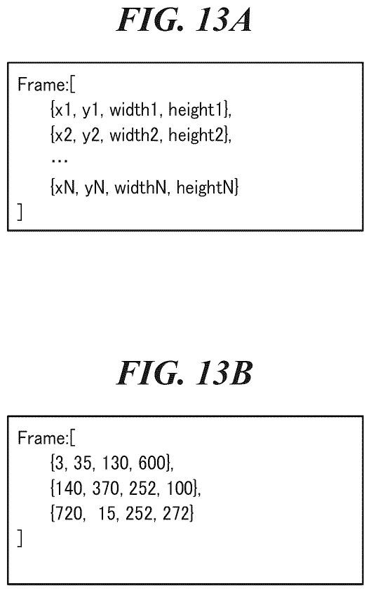

In a step S1104b, the browser processing module 250 notifies the browser control module 360 included in the image forming apparatus 101 of URL information indicating the location of the image data of the rendering result stored in the step S1104a. The browser processing module 250 also communicates frame information about the frame image detected in the step S1103b. The frame information is not particularly limited, and includes, for example, location information of the frame image and size information of the frame image (see FIGS. 13A and 13B).

In a step S1105, the browser control module 360 of the image forming apparatus 101 requests to obtain the image data from the storage device 109 of the image generation system 100 on the basis of the URL information notified in the step S1104b.

In a step S1106, the browser control module 360 receives the image data from the storage device 109 as a result of the request to obtain the image data in the step S1105.

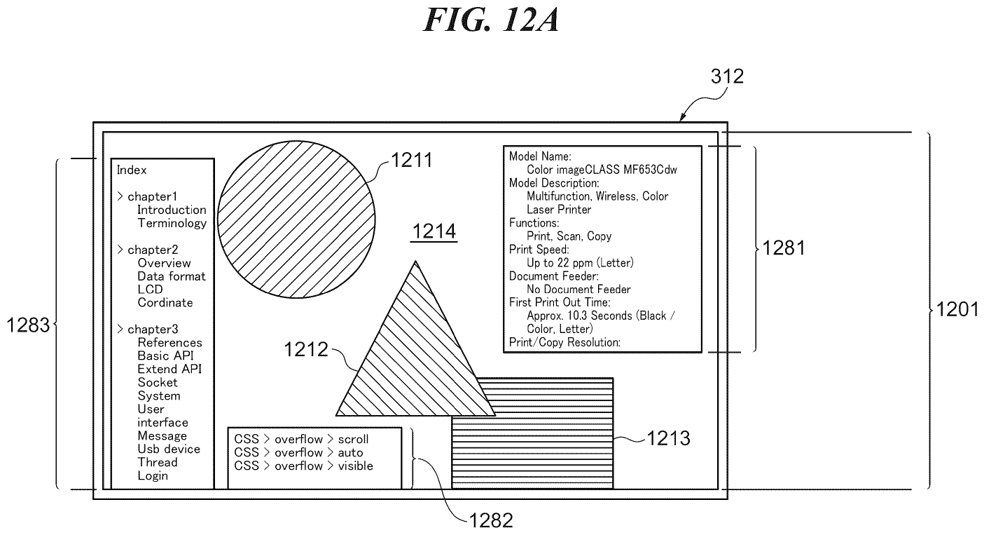

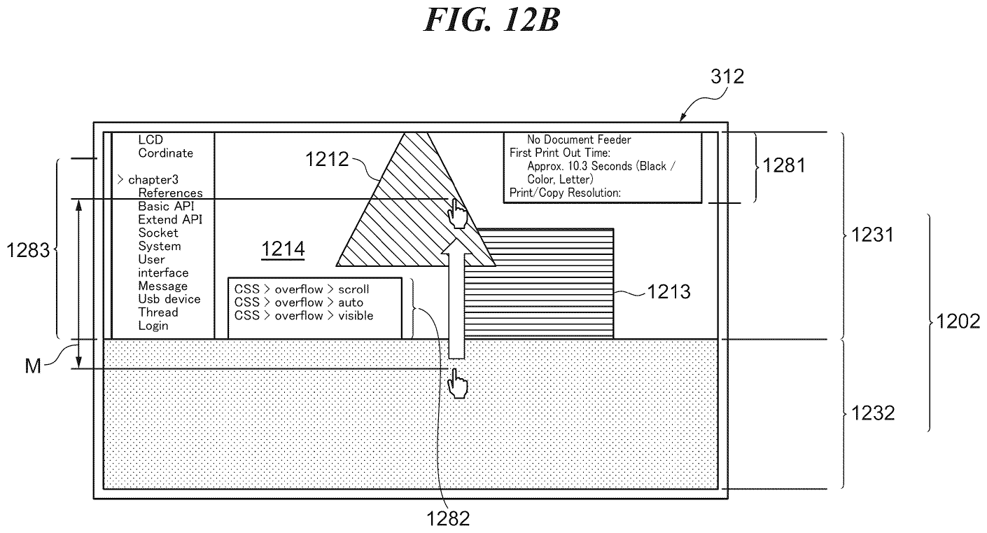

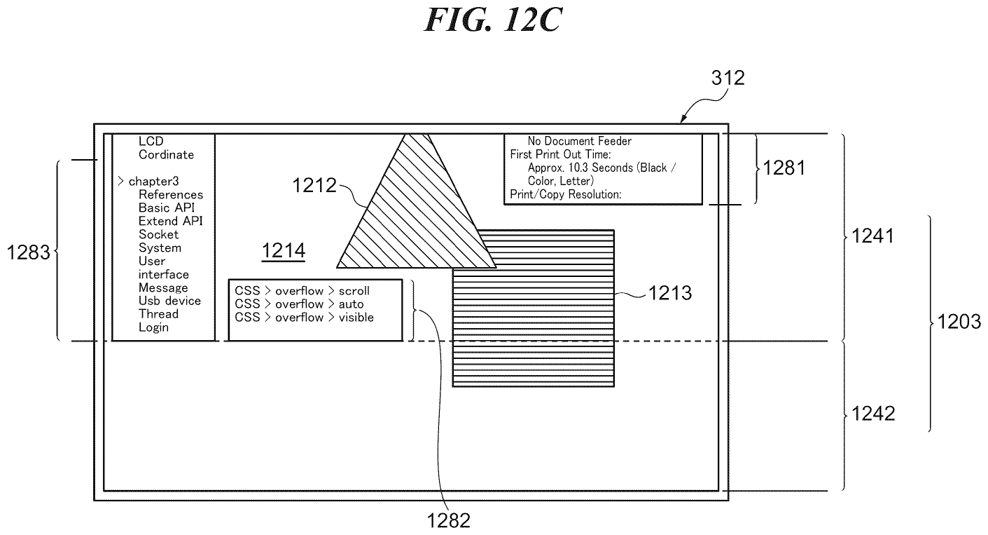

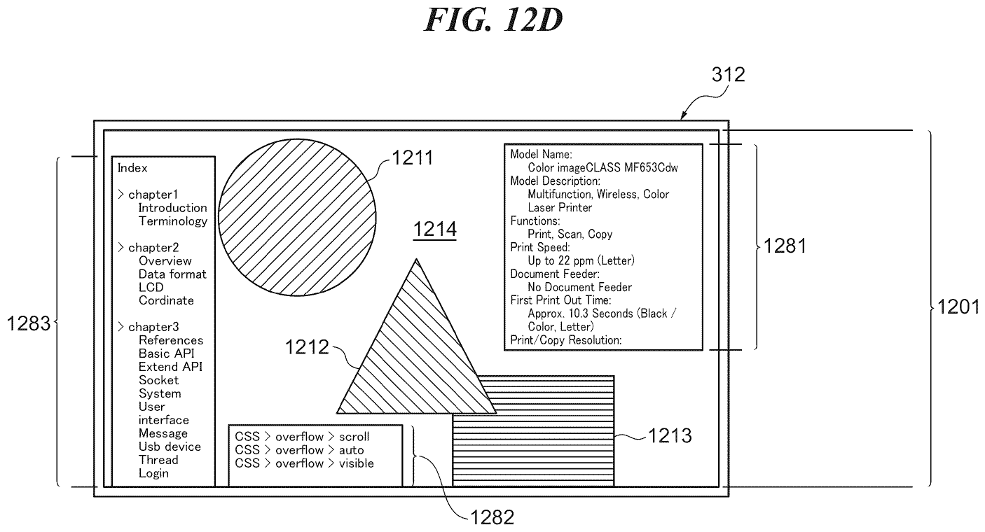

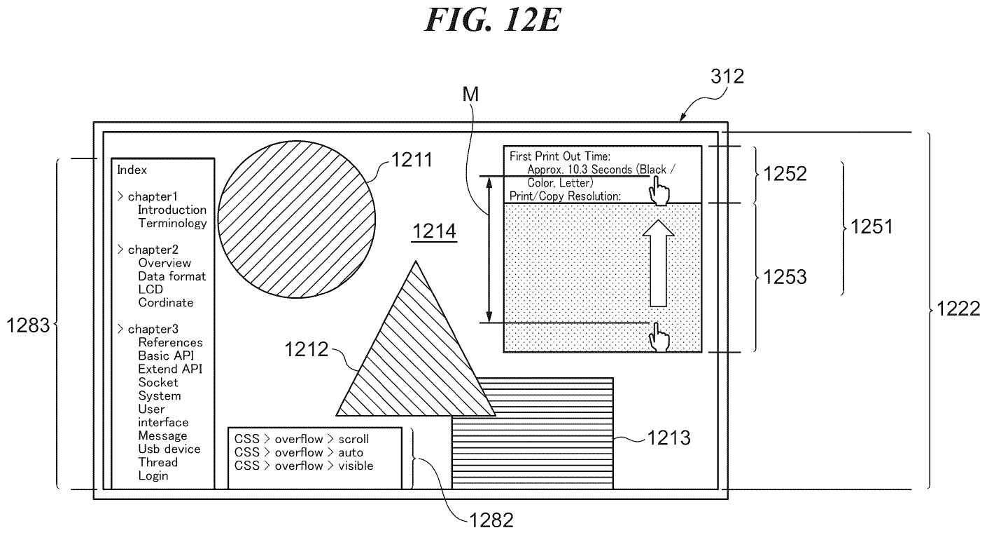

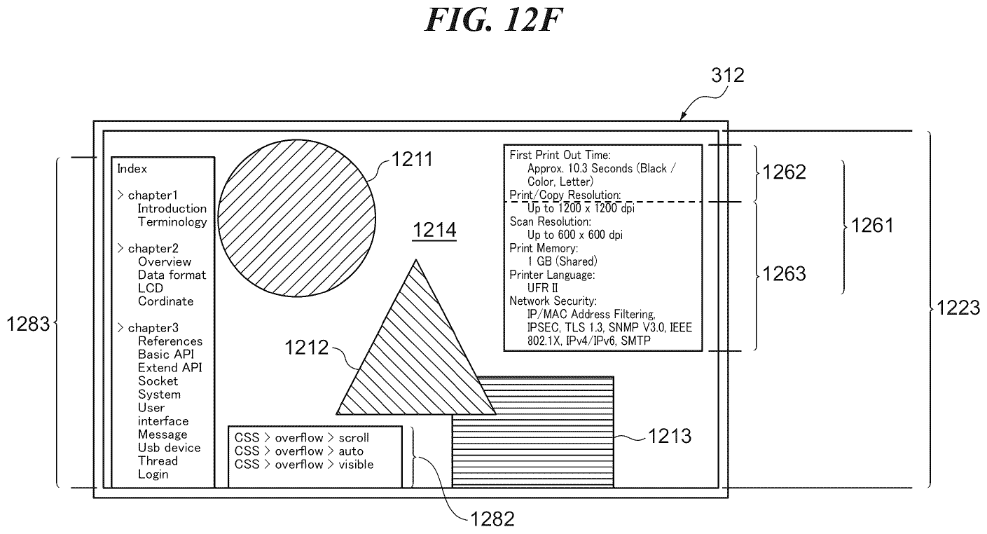

In a step S1107, the browser control module 360 instructs the UI control module 352 to render the image data received in the step S1106. As a result, the draggable image of the image data is displayed on the operation device 312. For example, an image shown in FIG. 12A or an image shown in FIG. 12D is displayed here. Each image will be described later.

In a step S1108, the user taps in on the draggable image displayed on the operation device 312 in the step S1107. Then, an electric signal corresponding to the tap-in is transmitted from the operation device 312 to the UI control module 352. Thus, the UI control module 352 can specify the coordinate of the position of the fingertip on the basis of the electric signal. Note that the tap-in to the draggable image is divided into a case where the user taps in a part outside the frame image in the draggable image and a case where the user taps in a part inside the frame image in the draggable image. In any case, the drag is performed after the tap-in. The drag in the former case corresponds to steps S1111a to S1114a in FIG. 11B described later. On the other hand, the drag in the latter case corresponds to steps S1111b to S1114b in FIG. 11B described later.

In a step S1109, the UI control module 352 of the image forming apparatus 101 transmits information about the coordinate specified in the step S1108 to the browser control module 360 as a tap-in event.

In a step S1110, the browser control module 360 stores the information about the coordinate of the tapped position (the start coordinate) transmitted from the UI control module 352 in the step S1109 in the RAM 302.

In a step S1111a, the user drags the fingertip tapped in the part outside the frame image in the draggable image in the step S1108 as-is on the touch panel. Then, an electric signal that varies in accordance with the drag is transmitted from the operation device 312 to the UI control module 352. Thus, the UI control module 352 can specify the coordinate that varies in accordance with the movement of the fingertip on the basis of the electric signal.

In a step S1112a, the UI control module 352 transmits the information about the coordinate that is specified in the step S1111a and is varying with the movement of the fingertip to the browser control module 360 as a drag event.

In a step S1113a, the browser control module 360 calculates the coordinate of the start point and the coordinate of the end point of the drag operation in the area outside the frame image in the draggable image on the basis of the information transmitted from the UI control module 352 in the step S1112a. The calculation result by the browser control module 360 is stored in the RAM 302.

In a step S1114a, the browser control module 360 instructs the UI control module 352 to render the image data on the basis of the coordinate of the start point and the coordinate of the end point calculated in the step S1113a. Thus, a partial image of the image data is displayed on the operation device 312. For example, an image shown in FIG. 12B is displayed as the image including the partial image. This image will be described later.

The above steps S1111a to S1114a are related to the drag after the tap-in to the part outside the frame image in the draggable image.

In a step S1111b, the user drags the fingertip tapped in the part inside the frame image in the draggable image in the step S1108 as-is on the touch panel. Then, an electric signal that varies in accordance with the drag is transmitted from the operation device 312 to the UI control module 352. Thus, the UI control module 352 can specify the coordinate that varies in accordance with the movement of the fingertip on the basis of the electric signal.

In a step S1112b, the UI control module 352 transmits the information about the coordinate that is specified in the step S1111b and is varying with the movement of the fingertip to the browser control module 360 as a drag event.

In a step S1113b, the browser control module 360 calculates the coordinate of the start point and the coordinate of the end point of the drag operation in the frame image on the basis of the information transmitted from the UI control module 352 in the step S1112b. The calculation result by the browser control module 360 is stored in the RAM 302.

In a step S1114b, the browser control module 360 instructs the UI control module 352 to render the image data on the basis of the coordinate of the start point and the coordinate of the end point calculated in the step S1113b. Thus, a partial image of the image data is displayed on the operation device 312. For example, a partial image shown in FIG. 12E is displayed here. This image will be described later.

The above steps S1111b to S1114b are related to the drag after the tap-in to the frame image in the draggable image.

In a step S1115, the user taps out by releasing the fingertip from the image dragged in the step S1111a or S1111b. Then, an electric signal corresponding to the tap-out position is transmitted from the operation device 312 to the UI control module 352. Thus, the UI control module 352 can specify the coordinate of the position where the fingertip is separated on the basis of the electric signal.

In a step S1116, the UI control module 352 of the image forming apparatus 101 transmits the information about the coordinate specified in the step S1115 to the browser control module 360 as a tap-out event.

In a step S1117, the browser control module 360 determines whether the operation performed by the user in the steps S1108 to S1115 is an operation including a drag. As described above, since the drag is performed in the step S1111a or S1111b, it is determined that the operation includes the drag in the step S1117. Then, the browser control module 360 calculates the moving amount of the fingertip in the drag (the scroll amount of the image).

In a step S1118, the browser control module 360 transmits the information about the moving amount (scroll amount) calculated in the step S1117 to the browser processing module 250 of the image generation system 100.

In a step S1119a, the browser processing module 250 performs a scroll process to generate the image data based on the moving amount transmitted in the step S1118.

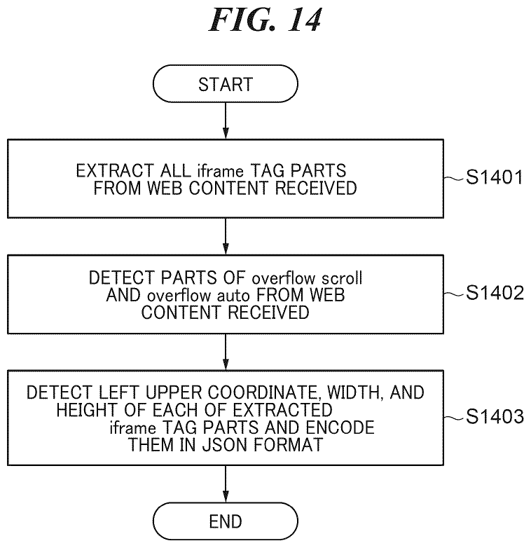

In a step S1119b, the browser processing module 250 detects the frame image included in the draggable image. The frame image detection process will be described later with reference to FIG. 14.

In a step S1120a, the browser processing module 250 stores the image data generated in the step S1119a in the storage device 109.

In a step S1120b, the browser processing module 250 notifies the browser control module 360 included in the image forming apparatus 101 of the URL information indicating the location of the image data stored in the step S1120a. The browser processing module 250 also communicates the frame information about the frame image detected in the step S1119b.

In a step S1121, the browser control module 360 of the image forming apparatus 101 requests to obtain the image data from the storage device 109 of the image generation system 100 on the basis of the URL information notified in the step S1120b.

In a step S1122, the browser control module 360 receives the image data from the storage device 109 as a result of the request to obtain the image data in the step S1121. The image data is the image data stored in the step S1120a.

In a step S1123, the browser control module 360 instructs the UI control module 352 to render the image data received in the step S1122. As a result, the image of the image data is displayed on the operation device 312. For example, an image shown in FIG. 12C or an image shown in FIG. 12F is displayed here. Each image will be described later.

FIGS. 12A to 12C are views showing examples of images displayed on the operation device of the image forming apparatus. FIG. 12A shows an image displayed before the moving operation. FIG. 12B shows an image displayed during the moving operation. FIG. 12C shows an image displayed after the moving operation. In a state shown in FIG. 12A, a first image (first draggable image) 1201 that can be dragged is displayed on the operation device 312. The first image 1201 includes frame images 1281, 1282, and 1283. Each of the frame images 1281 to 1283 includes a plurality of characters representing a program language and a message, for example. A drag operation for each of the frame images 1281 to 1283 (an image moving operation for each frame image) is possible separately from the drag operation for the first image 1201. The frame images 1281 to 1283 can be dragged independently. Thus, the user can drag any of the frame images 1281 to 1283, that is, a desired frame image. The number of frame images arranged in the first image 1201 is three in this embodiment, but is not limited thereto, and may be at least one. The first image 1201 includes a first object 1211 having a circular shape, a second object 1212 having a triangular shape, and a third object 1213 having a quadrangular shape. A background 1214 of the first image 1201 is mainly white. In the first image 1201, the positions of the frame images 1281, 1282, and 1283 are respectively fixed to the positions of the first object 1211, the second object 1212, and the third object 1213. The first image 1201 is an image obtained as a result of rendering by the browser processing module 250 of the image generation system 100.

In a state shown in FIG. 12B, a second image 1202 is displayed on the operation device 312. The second image 1202 includes a moved image 1231 and a blank image 1232. The second image 1202 is generated by the browser control module 360 of the image forming apparatus 101. The moved image 1231 is an image indicating a state where the first image 1201 is moved by the moving amount M when the moving operation is applied to a part (the background 1214, for example) other than the frame images 1281 to 1283 in the first image 1201 by the drag. The moved image 1231 includes the frame image 1281 whose size is reduced by the moving amount M, the frame image 1282 whose size is not changed, and the frame image 1283 whose size is reduced by the moving amount M. The moved image 1231 includes the second object 1212 whose size is reduced by the moving amount M and the third object 1213 whose size is not changed. In the moved image 1231, the first object 1211 has disappeared. The background 1214 is white as-is. The blank image 1232 is an image that becomes blank for the moving amount M in accordance with the movement of the first image 1201. When generating the second image 1202, the browser control module 360 fills the blank image 1232 with a color different from the color of the background 1214. When the moving operation of the first image 1201 is performed, the second image 1202 as described above is displayed. Then, the user can quickly grasp the moving amount M by the moving operation by checking the blank image 1232 included in the second image 1202.

In a state shown in FIG. 12C, a third image (third draggable image) 1203 is displayed on the operation device 312. The third image 1203 is an image as a result that the browser processing module 250 of the image generation system 100 rendered. The image data of the third image 1203 is transmitted from the browser processing module 250 to the image forming apparatus 101. Thus, in the image forming apparatus 101, after the second image 1202 is displayed, the second image 1202 can be replaced with the third image 1203. The third image 1203 includes a corresponding image 1241 corresponding to the moved image 1231 and an auxiliary image 1242 that is continuously connected to the corresponding image 1241 and fills the blank image 1232. The corresponding image 1241 includes the frame image 1281 whose size is reduced by the moving amount M, the frame image 1282 whose size is not changed, and the frame image 1283 whose size is reduced by the moving amount M as with the moved image 1231. Further, the moved image 1241 includes the second object 1212 whose size is reduced by the moving amount M and the third object 1213 whose size is not changed as with the moved image 1231. The auxiliary image 1242 compensates for the size of the third object 1213 by the moving amount M. The background 1214 of the third image 1203 is white as-is. The first image 1201, the second image 1202, and the third image 1203 are displayed sequentially as described above, and thus the user can feel that the image has smoothly moved, that is, transitioned from the first image 1201 to the third image 1203.

FIGS. 12D to 12F are views showing examples of images displayed on the operation device of the image forming apparatus. FIG. 12D shows an image displayed before the moving operation. FIG. 12E shows an image displayed during the moving operation. FIG. 12F shows an image displayed after the moving operation. In a state shown in FIG. 12D, the first image 1201 that can be dragged is displayed on the operation device 312 as with FIG. 12A. The first image 1201 includes the frame images 1281, 1282, and 1283 and the first object 1211, the second object 1212, and the third object 1213. Here, as an example, the frame image 1281 among the frame images 1281 to 1283 is selected as a drag target image. Therefore, the frame image 1281 in the first image 1201 is the frame image before the drag (a first frame image).

In a state shown in FIG. 12E, the second image 1222 is displayed on the operation device 312. The second image 1222 is generated by the browser control module 360 of the image forming apparatus 101. The second image 1222 includes a frame image 1251. The frame image 1251 is an image obtained as a result of applying the moving operation to the frame image 1281. The second image 1222 includes the frame image 1282, the frame image 1283, and the first object 1211, the second object 1212, and the third object 1213 as with the first image 1201. The frame image 1251 includes a moved image (moved small image) 1252 and a blank image (blank small image) 1253. The moved image 1252 is an image indicating a state in which the frame image 1281 is moved by the moving amount M due to the moving operation applied to the frame image 1281 by an upward drag. In the moved image 1252, the number of characters (the number of lines) is reduced by the moving amount M. The blank image 1253 is an image that becomes a blank for the moving amount M in accordance with the movement of the frame image 1281. When generating the second image 1222, the browser control module 360 fills the blank image 1253 with a color different from the color of the moved image 1252 and the color the background 1214, for example. Then, the user can quickly grasp the moving amount M by the moving operation by checking the blank image 1253 included in the second image 1222.

In a state shown in FIG. 12F, a third image (third draggable image) 1223 is displayed on the operation device 312. The third image 1223 is an image as a result that the browser processing module 250 of the image generation system 100 rendered. The image data of the third image 1223 is transmitted from the browser processing module 250 to the image forming apparatus 101. Thus, in the image forming apparatus 101, after the second image 1222 is displayed, the second image 1222 can be replaced with the third image 1223. The third image 1223 includes a frame image 1261 instead of the frame image 1251 in the second image 1222. The third image 1223 includes the frame image 1282, the frame image 1283, and the first object 1211, the second object 1212, and the third object 1213, as with the second image 1222. The frame image 1261 includes a corresponding image 1262 corresponding to the moved image 1252 of the frame image 1251 and an auxiliary image 1263 that is continuously connected to the corresponding image 1262 and fills the blank image 1253. In the corresponding image 1262, the number of characters (the number of lines) is reduced by the moving amount M as with the moved image 1252. In the auxiliary image 1263, the number of characters (the number of lines) that is lacked by the moving amount M is newly supplemented. The first image 1208, the second image 1222, and the third image 1223 are displayed in this order, and thus the user can feel that the frame image transitions smoothly.

FIG. 13A and FIG. 13B are views showing examples of frame information related to frame images. The frame information is configured in a JSON format. FIG. 13A shows a general example of the frame information. FIG. 13B shows a specific example of the frame information. As shown in FIG. 13A, when the number of frame images is N (N is an integer), an upper left corner coordinate (xi, yi), a width (width_i), and a height (height_i) of each frame image are encoded in the JSON format as the frame information. Note that “i” is integer from “1” to “N”. FIG. 13B shows the frame information in a case where there are three frame images. For example, the upper left corner coordinate (3, 35), the width (130), and the height (600) of the first frame image are encoded in the JSON format as the frame information.

FIG. 14 is a flowchart showing a processing executed by the image generation system (the browser processing module). The flowchart shown in FIG. 14 shows the process of detecting a frame image. As shown in FIG. 14, in a step S1401, the browser processing module 250 extracts all iframe tag parts indicating frame images in an HTML document, which is a web content received from the external site 105, using JavaScript, for example. An iframe tag part is described as follows, for example.
<iframe src=“http://hogehoge.com/”></iframe>

In a step S1402, the browser processing module 250 detects “scroll” and “auto” included in the style “overflow” of CSS (Cascading Style Sheets) from the web content. The term “scroll” refers to a drag in a draggable (scrollable) area. The “auto” indicates that “scroll” or other operations are possible. When “scroll” or “auto” is detected, a drag on a frame image is enabled. Note that it is not necessary to detect “scroll” and “auto” as long as a drag on the screen is possible.

In a step S1403, the browser processing module 250 detects the upper left corner coordinate (xi, yi), the width (width_i), and the height (height_i) of the iframe tag part (frame image) extracted in the step S1401 as the frame information. This frame information is encoded in the JSON format (see FIGS. 13A and 13B).

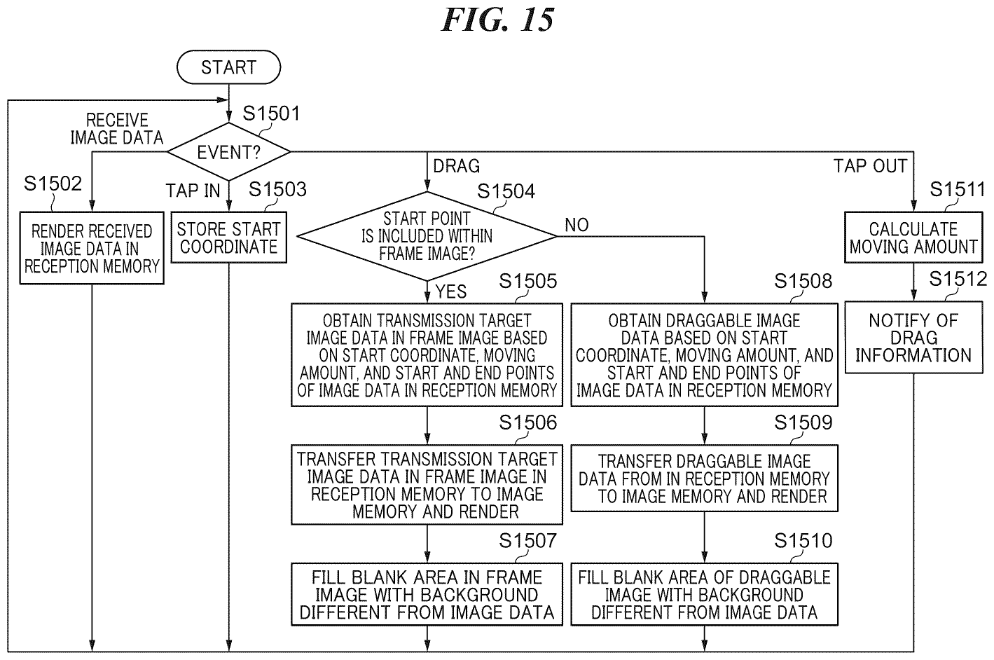

FIG. 15 is a flowchart showing a process executed by the image forming apparatus (browser control module). Steps S1501 to S1503 of the flowchart shown in FIG. 15 are the same as the steps S1001 to S1003 of the flowchart shown in FIG. 10A. Further, steps S1511 and S1512 are the same as the steps S1007 and S1008.

As shown in FIG. 15, in a step S1504 after execution of the step S1501, the browser control module 360 determines whether the coordinate stored in the step S1503 (the tap-in start coordinates) is included in any of the frame images within the draggable image. In this way, the browser control module 360 has a function as a determination unit that determines whether the drag after the tap-in on the operation device 312 is a moving operation to the draggable image or a moving operation to the frame image. Then, the subsequent control is performed on the basis of the determination result. The determination in the step S1504 is based on whether the start coordinate is included in the area defined by the upper left corner coordinate (xi, yi), the width (width_i), and the height (height_i) of the frame information. Then, as a result of the determination in the step S1504, when it is determined that the start coordinate is included in the frame image, the process proceeds to a step S1505. On the other hand, as a result of the determination in the step S1504, when it is determined that the start coordinate is not included in the frame image, that is, the start coordinate is outside the frame image, the process proceeds to a step S1508.

In step S1505, the browser control module 360 obtains data of the transmission target image in the frame image on the basis of the start coordinate stored in the step S1503, the moving amount M, and the start point and the end point of the image data in the reception memory, as with the step S1004. The width of the transmission target image is the same as the width of the frame image. After the execution of the step S1505, the process proceeds to a step S1506.

In the step S1506, the browser control module 360 transfers the data of the transmission target image in the frame image in the reception memory obtained in the step S1505 to the image memory and causes the UI control module 352 to render the data in the image memory. After the execution of the step S1506, the process proceeds to a step S1507.

In the step S1507, the browser control module 360 transfers the data of the background different from the moved image of the frame image to the area to be the blank image of the frame image on the image memory and causes the UI control module 352 to render the blank image of the frame image. After the execution of the step S1507, the process returns to the step S1501, and the subsequent steps are sequentially executed.

In the step S1508, the browser control module 360 obtains a draggable image data on the basis of the start coordinate stored in the step S1503, the moving amount M, and the start and end points of the image data in the reception memory.

In a step S1509, the browser control module 360 transfers the draggable image data in the reception memory obtained in the step S1508 to the image memory and causes the UI control module 352 to render the data in the image memory. After the execution of the step S1509, the process proceeds to a step S1510.

In the step S1510, the browser control module 360 transfers data of a background different from the moving image (image data) to an area to be a blank image in the image memory and causes the UI control module 352 to render the blank image. After the execution of the step S1510, the process returns to the step S1501, and the subsequent steps are sequentially executed.

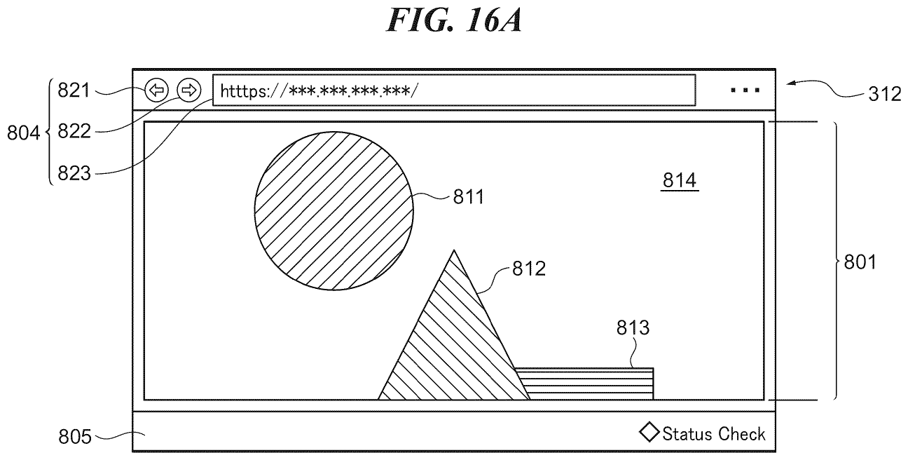

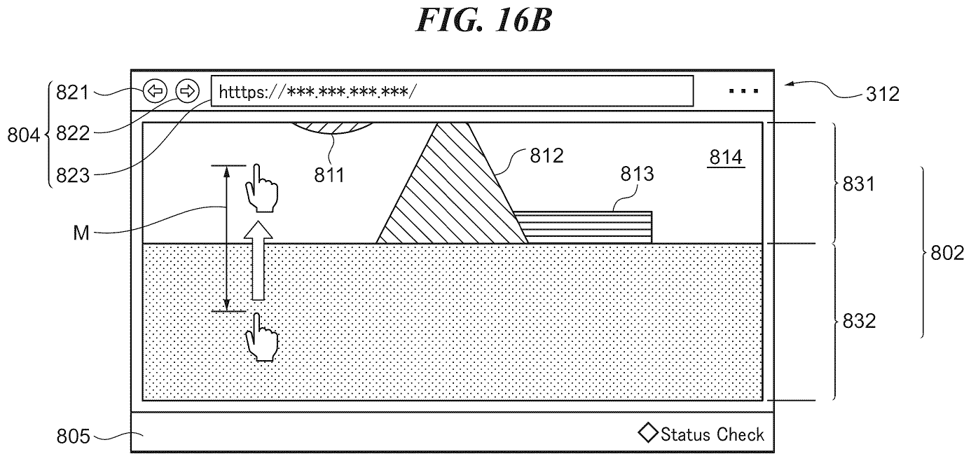

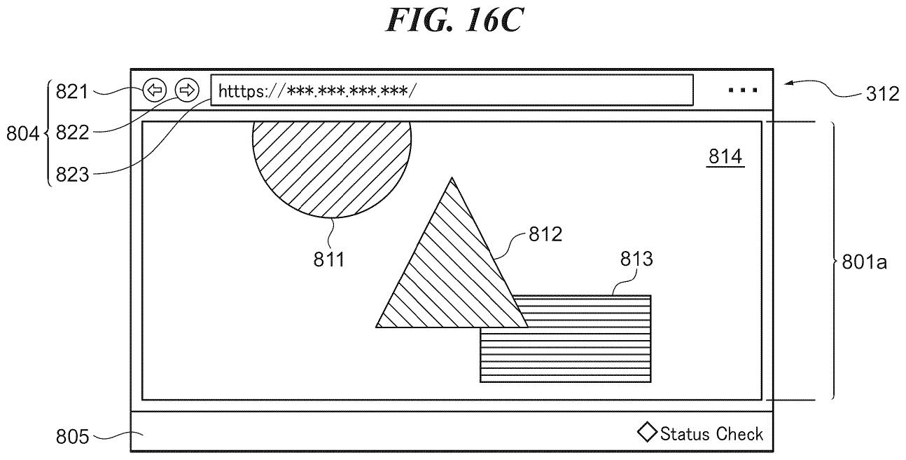

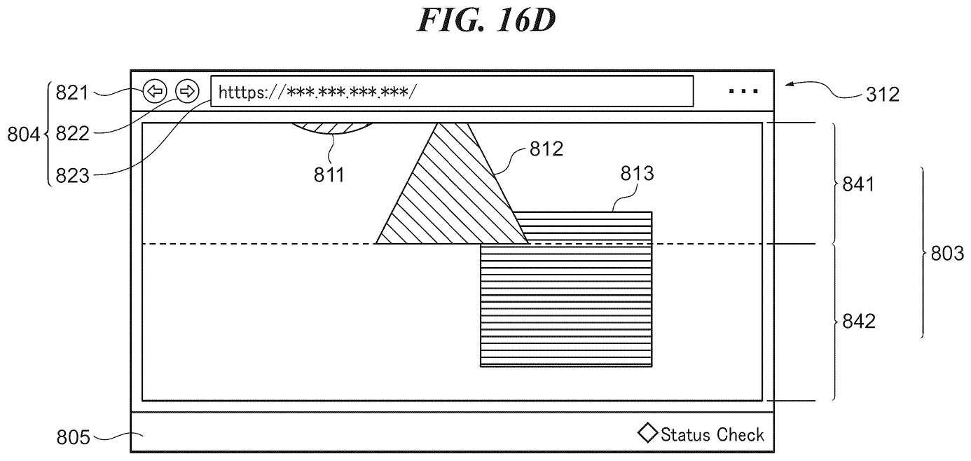

Hereinafter, a third embodiment will be described with reference to FIGS. 16A to 19, but differences from the above-described embodiments will be mainly described and the descriptions of the same matters will be omitted. This embodiment is the same as the first embodiment except that the process executed by the image generation system is different. FIGS. 16A to 16D are views showing examples of images displayed on an operation device of an image forming apparatus of a cloud browser system according to the third embodiment. FIG. 16A shows an image displayed before a moving operation. FIG. 16B shows an image displayed during the moving operation. FIG. 16C shows an image displayed during the moving operation after displaying the image shown in FIG. 16B. FIG. 16D is an image displayed after the moving operation. Here, differences from FIGS. 8A, 8B, and 8C, and the descriptions of the same matters will be omitted. In a state shown in FIG. 16A, the first image 801, the first information image 804, and the second information image 805 are displayed on the operation device 312. The state shown in FIG. 16A is the same as that shown in FIG. 8A. In a state shown in FIG. 16B, the second image 802, the first information image 804, and the second information image 805 are displayed on the operation device 312. The state shown in FIG. 16C is the same as that shown in FIG. 8B. In FIG. 16D, the third image 803, the first information image 804, and the second information image 805 are displayed on the operation device 312. The state shown in FIG. 16D is the same as that shown in FIG. 8C. The state shown in FIG. 16C is different from that shown in FIGS. 8A to 8C.

In a state shown in FIG. 16C, an intermediate image 801a, the first information image 804, and the second information image 805 are displayed on the operation device 312. The intermediate image 801a is an image displayed next to the second image 802. The first image 801a shows a state where the image moving operation by the moving amount M performed as shown in FIG. 16B is not sufficiently reflected. In this case, the user may feel as if the second image 802 returns to the first image 801. The intermediate image 801a is displayed, for example, when the image forming apparatus 101 does not wait for the reception of the image data of the third image 803 generated by the image generation system 100 or when the reception is insufficient. In addition, the intermediate image 801a is displayed when the image data of the third image 803 is insufficiently transmitted from the image generation system 100.

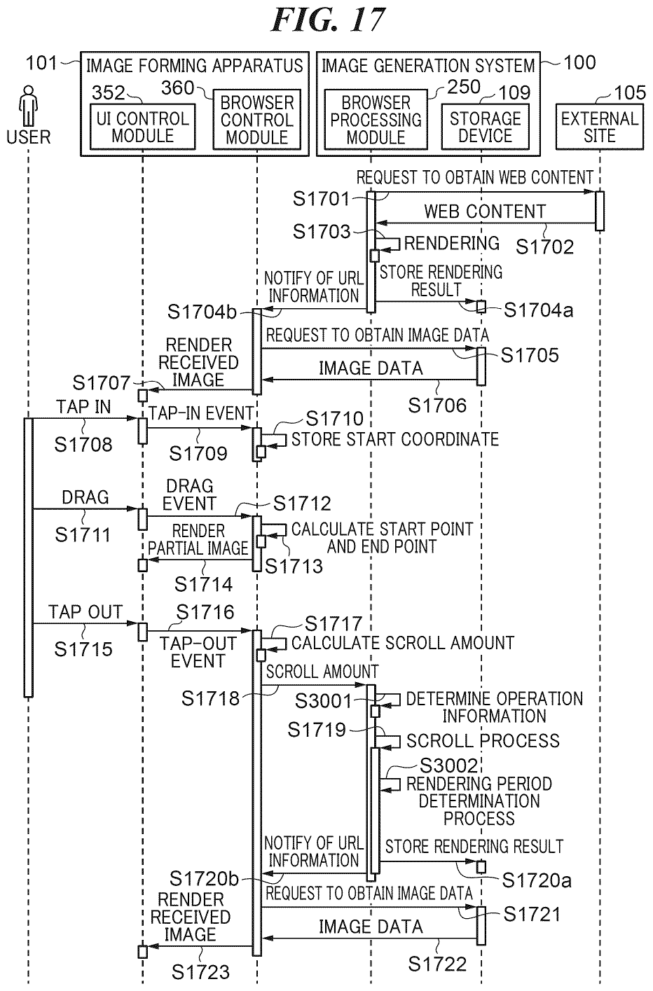

Therefore, the image generation system 100 is configured to suppress the phenomenon in which the intermediate image 801a is displayed. The configuration and operation will be described below. FIG. 17 is a sequential chart showing an example of a process executed between the image forming apparatus, the image generation system, and the external site. Steps S1701 to S1718 in the sequential chart shown in FIG. 17 are the same as the steps S701 to S718 in the sequential chart shown in FIG. 7. After the execution of the step S1718, a step S3001, a step S1719, and a step S3002 are sequentially executed. A step S1719 is the same as the step S719 in the sequential chart shown in FIG. 7. After the execution of the step S3002, steps S1720a to S1723 are sequentially executed. The steps S1720a to S1723 are the same as the steps S720a to 723 in the sequential chart shown in FIG. 7.

In the step S3001, the browser processing module 250 receives the operation information from the image forming apparatus 101 and determines whether the operation information is information related to an image moving operation (a scroll operation) for moving an image displayed on the operation device 312 of the image forming apparatus 101.

In the step S3002, the browser processing module 250 executes a rendering period determination process to determine whether the generation of the third image 803 in the step S1719 is completed (a determination step). Thus, in this embodiment, the browser processing module 250 also has a function as a determination unit that determines whether the generation of the third image 803 is completed. Note that step S3002 is executed whenever the rendering is performed in the step S1719.

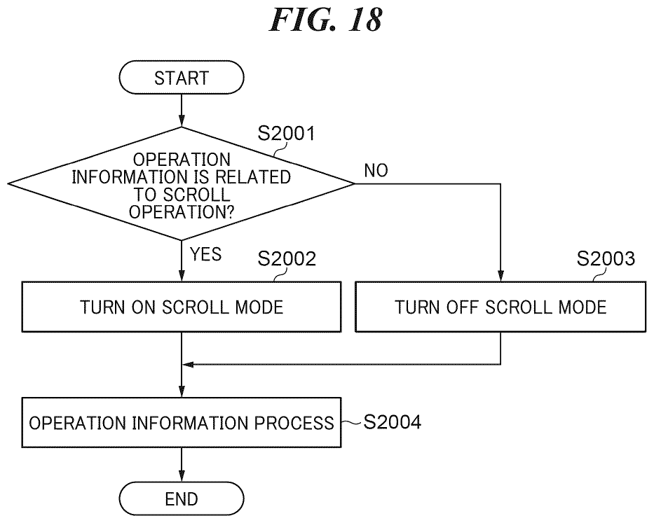

FIG. 18 is a flowchart showing a process executed in the image generation system. As shown in FIG. 18, in a step S2001, the browser processing module 250 determines whether the operation information from the image forming apparatus 101 relates to a scroll operation to scroll (drag) the image displayed on the operation device 312 of the image forming apparatus 101. As a result of the determination in the step S2001, when it is determined that the information relates to a scroll operation, the process proceeds to a step S2002. On the other hand, as a result of the determination in the step S2001, when it is determined that the information does not relates to a scroll operation, the process proceeds to a step S2003.

In the step S2002, the browser processing module 250 turns ON a scroll mode. This enables to start the generation of the image displayed after the scroll operation, that is, the image data of the third image 803 (the step S1719).

In the step S2003, the browser processing module 250 turns OFF the scroll mode. This omits the generation of the image data of the third image 803 (the step S1719).

In a step S2004, the browser processing module 250 executes the process of generating the image data of the third image 803 (the step S1719) as the process based on the operation information.

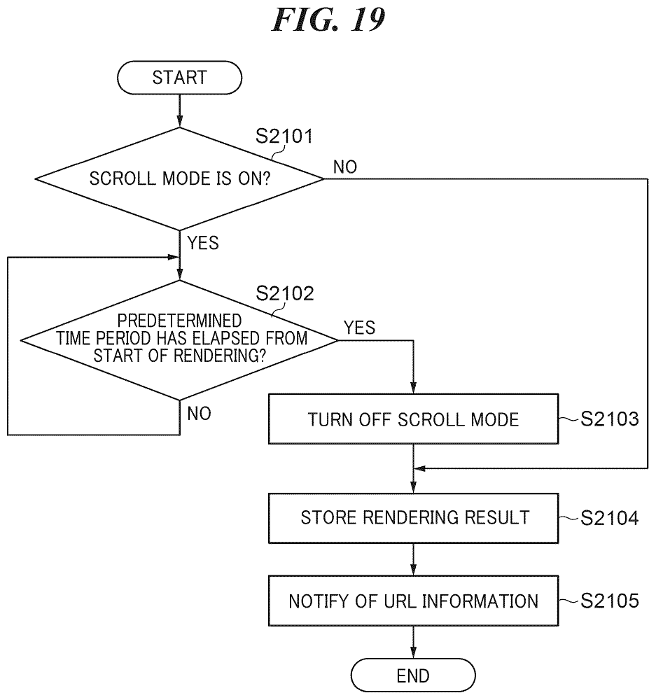

FIG. 19 is a flowchart showing a process that is executed by the image generation system at a timing different from the execution timing of the process shown in FIG. 18. As shown in FIG. 19, in a step S2101, the browser processing module 250 of the image generation system 100 determines whether the scroll mode is ON. As a result of the determination in the step S2101, when it is determined that the scroll state is ON, the process proceeds to a step S2102. On the other hand, as a result of the determination in the step S2101, when it is determined that the scroll mode is not ON, that is, the scroll mode is OFF, the process proceeds to a step S2104.

In the step S2102, the browser processing module 250 determines whether a predetermined time period has elapsed from the start of the generation (rendering) of the image data of the third image 803. As a result of the determination in the step S2102, when it is determined that the predetermined time period has elapsed, the process proceeds to a step S2103. On the other hand, as a result of the determination in the step S2102, when it is determined that the predetermined time period has not elapsed, the process remains in the step S2102, that is, the process waits until the predetermined time period elapses. The predetermined time period is appropriately set according to, for example, the processing speed of the browser processing module 250, but is not particularly limited. The predetermined time period is preferably changeable.

In the step S2103, the browser processing module 250 turns OFF the scroll mode. Thus, it is determined that the generation of the image data of the third image 803 is completed.

In the step S2104, the browser processing module 250 stores the image data of the third image 803 as the rendering result in the storage device 109 (the step S1720a).

In a step S2105, the browser processing module 250 notifies the browser control module 360 included in the image forming apparatus 101 of the URL information (the step S1720b) indicating the location of the image data stored in the step S2104. After the step S2105 is executed, the process is terminated.

As described above, in this embodiment, the image generation system 100 waits for the transmission of the image data of the third image 803 to the image forming apparatus 101 until it is determined that the generation of the image data of the third image 803 is completed. Then, when it is determined that the generation of the image data of the third image 803 is completed, the image data of the third image 803 is transmitted to the image forming apparatus 101 (the notification of the URL information in this embodiment). Accordingly, the phenomenon in which the intermediate image 801a is displayed is suppressed, and the first image 801 (see FIG. 16A), the second image 802 (see FIG. 16B), and the third image 803 (see FIG. 16D) are sequentially displayed on the operation device 312 of the image forming apparatus 101. Such image change allows the user to feel that the image on the operation device 312 has moved smoothly and successfully.

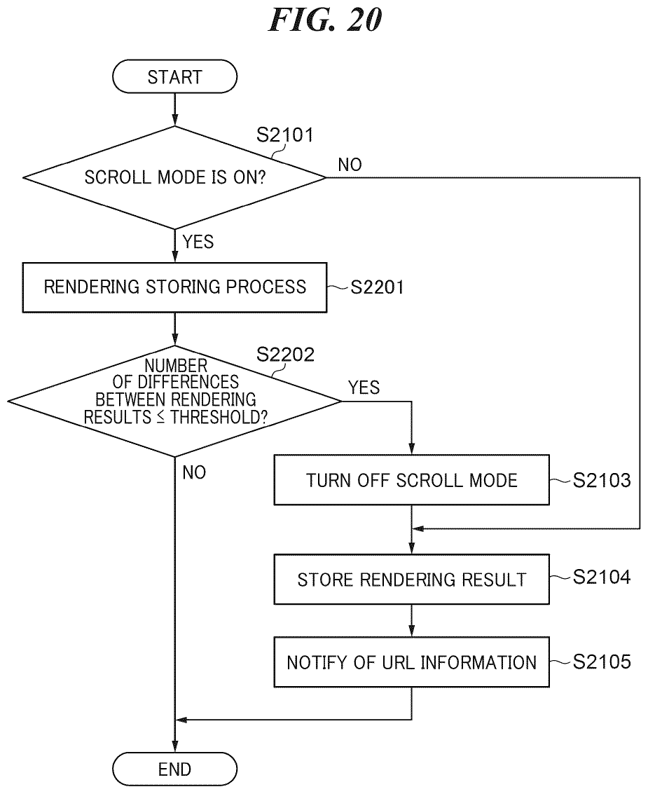

Hereinafter, a fourth embodiment will be described with reference to FIG. 20, but differences from the above-described embodiments will be mainly described and descriptions of the same matters will be omitted. This embodiment is the same as the third embodiment except that the process executed by the image generation system is different. FIG. 20 is a flowchart showing a process executed by an image generation system of a cloud browser system according to the fourth embodiment. In the flowchart shown in FIG. 20, a step S2201 and a step S2202 are executed in order instead of the step S2102 in the flowchart shown in FIG. 19. As shown in FIG. 20, as a result of the determination in the step S2101, when it is determined that the scroll state is ON, the process proceeds to the step S2201.

In the step S2201, the browser processing module 250 of the image generation system 100 stores the rendering results, for example, in the storage device 109. The rendering result stored here is the result of the rendering executed in the step S1719, and in this embodiment, the image data of the two third images 803 generated at different timings. The image data of the two third images 803 may be, for example, the image data obtained within the predetermined time period.

In the step S2202, the browser processing module 250 compares the image data of the two third images 803 (the rendering results) stored in the step S2201 and determines whether the number of differences between the image data of the two images is equal to or less than a threshold. As a result of the determination in the step S2202, when it is determined that the number of differences is equal to or less than the threshold, the process proceeds to the step S2103. As described above, in the step S2103, the scroll mode is turned OFF and it is determined that the generation of the image data of the third image 803 is completed. On the other hand, as a result of the determination in the step S2202, when it is determined that the number of differences is more than the threshold, the process is terminated. Although the image data of the two third images 803 are compared to find the differences in the step S2202 in this embodiment, this is not limiting. For example, the image data of three or more third images 803 may be compared. The threshold is stored in advance in the storage device 109, for example. The threshold is preferably changeable as appropriate.

As with the third embodiment, in this embodiment, the image generation system 100 waits to transmit the image data of the third image 803 to the image forming apparatus 101 until it is determined that generation of the image data of the third image 803 is complete. Then, when it is determined that the generation of the image data of the third image 803 is completed, the image data of the third image 803 is transmitted to the image forming apparatus 101. Accordingly, the phenomenon in which the intermediate image 801a is displayed is suppressed, and the first image 801 to the third image 803 are sequentially displayed on the operation device 312 of the image forming apparatus 101. Such image change allows the user to feel that the image on the operation device 312 has moved smoothly and successfully.

Although the preferred embodiments of the present invention have been described above, the present invention is not limited to the above-described embodiments, and various modifications and changes can be made within the scope of the gist of the present invention. Further, the information processing apparatus is the image forming apparatus 101 in the respective embodiments, but is not limited thereto, and may be, for example, a desktop or notebook personal computer, a smartphone, or the like.

In the cloud browser system 1000, for example, the image generation system 100 as a server may be installed outside Japan, and the image forming apparatus 101 as a terminal device may be installed in Japan. Even in such a case, the server is able to transmit a file and data to the terminal device, and the terminal device is able to receive the file and data. Even when the server is located outside Japan, the cloud browser system 1000 can transmit and receive the file and data as one unit. In the cloud browser system 1000, even when the server is located outside Japan and the terminal device is located in Japan, the terminal device can perform the main function of the cloud browser system 1000. Further, the effect of the function can be exhibited in Japan. For example, even if the server is located outside Japan, if the terminal device constituting the cloud browser system 1000 is located in Japan, the system can be used in Japan by using the terminal device.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2023-204679, filed Dec. 4, 2023 and No. 2024-064559, filed Apr. 12, 2024, which are hereby incorporated by reference herein in their entireties.

What is claimed is:

1. An information processing system comprising:
an information processing apparatus comprising:
a display device that displays image data obtained from a server communicably connected to the information processing apparatus as an image;
an operation device that accepts a moving operation by a user for moving the image displayed on the display device;
an apparatus-side memory device that stores a set of instructions; and
at least one apparatus-side processor that executes the set of instructions to:
transmit operation information regarding a moving amount by the moving operation to the server after the moving operation is ended;
display the image before the moving operation as a first image on the display device; and
display a second image in a case where the moving operation is applied to the first image, the second image including a moved image in a state where the first image is moved by the moving operation and a blank image that becomes a blank in accordance with movement of the first image; and
the server comprising:
a server-side memory device that stores a set of instructions; and
at least one server-side processor that executes the set of instructions to:
receive the operation information from the information processing apparatus;
generate image data of a third image including an image corresponding to the moved image and an image that is continuously connected to the moved image and fills the blank image based on the operation information received; and
transmit the image data of the third image to the information processing apparatus, and
wherein the at least one apparatus-side processor executes the set of instructions to displaying the third image based on the image data received from the server on the display device in place of the second image.

2. The information processing system according to claim 1, wherein the first image includes at least one small image to which a small-image moving operation by the operation device is applicable separately from the moving operation to the first image, and
wherein the at least one apparatus-side processor executes the set of instructions to:
display the small image before the small-image moving operation as a first small image in the first image,
display a second small image in the first image in a case where the small-image moving operation is applied to the first small image, the second small image including a moved small image in a state where the first small image is moved by the small-image moving operation and a blank small image that becomes a blank in accordance with movement of the first small image.

3. The information processing system according to claim 2, wherein the at least one server-side processor executes the set of instructions to generate image data of a third small image including an image corresponding to the moved small image and an image that is continuously connected to the moved small image and fills the blank small image, and
wherein the at least one apparatus-side processor executes the set of instructions to control the display device to replace the second small image with the third small image after displaying the second small image.

4. The information processing system according to claim 2, wherein the first image includes a plurality of small images, and the small-image moving operations are respectively applicable to the plurality of small images independently.

5. The information processing system according to claim 2, wherein the at least one apparatus-side processor executes the set of instructions to:
determine whether the moving operation is applied to the first image and whether the small-image moving operation is applied to the small image, and
control based on the determination result.

6. The information processing system according to claim 1, wherein the moved image includes a background, and
wherein the at least one apparatus-side processor executes the set of instructions to fill the blank image with a color different from a main color of the background.

7. The information processing system according to claim 1, wherein the at least one apparatus-side processor executes the set of instructions to change a display area of the moved image and a display area of the blank image in conjunction with the moving operation.

8. The information processing system according to claim 7, wherein the at least one apparatus-side processor executes the set of instructions to narrow the display area of the moved image in conjunction with the moving operation and widen the display area of the blank image corresponding to the display area of the moved image narrowed.

9. The information processing system according to claim 1, wherein the display device includes a touch panel having a touch function, and the operation device is achieved by the touch function.

10. The information processing system according to claim 9, wherein the moving operation is performed by a drag that slides a finger on the touch panel.

11. The information processing system according to claim 1, wherein the information processing apparatus includes a storage device that stores image data from the server.

12. The information processing system according to claim 1, wherein the display device displays an image of a web site as the image.

13. The information processing system according to claim 1, wherein the information processing apparatus is an image forming apparatus having at least one of a print function, a scan function, and a facsimile function.

14. A server communicably connected to an information processing apparatus, the server comprising:
a server-side memory device that stores a set of instructions; and
at least one server-side processor that executes the set of instructions to:
receive operation information regarding a moving operation for moving an image displayed on a display device of the information processing apparatus, the operation information being transmitted from the information processing apparatus;
generate image data of a changed image in a state changed in accordance with the moving operation, based on the operation information received;
determine whether generation of the image data of the changed image is completed;
wait for transmission of the image data of the changed image to the information processing apparatus until it is determined that generation of the image data of the changed image is completed; and
transmit the image data of the changed image to the information processing apparatus in a case where it is determined that generation of the image data of the changed image is completed.

15. The server according to claim 14, wherein the at least one server-side processor that executes the set of instructions to determine that the generation of the image data of the changed image is completed in a case where a predetermined time period has elapsed from start of the generation of the image data of the changed image.

16. The server according to claim 14, wherein the at least one server-side processor that executes the set of instructions to determine that the generation of the image data of the changed image is completed in a case where a number of differences between the image data of the plurality of changed images generated at different timings is equal to or less than a threshold.

17. A control method for an information processing system having an information processing apparatus and a server communicably connected with the information processing apparatus, the control method comprising:
displaying image data obtained from the server as a first image on a display
device provided in the information processing apparatus;
receiving a moving operation by a user for moving the first image displayed on the display device by an operation device provided in the information processing apparatus;
transmitting operation information regarding a moving amount by the moving operation from the information processing apparatus to the server after the moving operation is ended;
displaying a second image including a moved image in a state where the first image is moved by the moving operation and a blank image that becomes a blank in accordance with movement of the first image on the display device;
receiving the operation information from the information processing apparatus by the server;
generating image data of a third image including an image corresponding to the moved image and an image that is continuously connected to the moved image and fills the blank image by the server based on the operation information received;
transmitting the image data of the third image to the information processing apparatus; and
displaying the third image based on the image data received from the server on the display device in place of the second image.

18. A control method for a server communicably connected to an information processing apparatus, the control method comprising:
receiving operation information regarding a moving operation for moving an image displayed on a display device of the information processing apparatus, the operation information being transmitted from the information processing apparatus;
generating image data of a changed image in a state changed in accordance with the moving operation, based on the operation information received;
determining whether generation of the image data of the changed image is completed; and
waiting for transmission of the image data of the changed image to the information processing apparatus until it is determined that generation of the image data of the changed image is completed; and
transmitting the image data of the changed image to the information processing apparatus in a case where it is determined that generation of the image data of the changed image is completed.

19. A non-transitory computer-readable storage medium storing a control program causing a computer to execute a control method for an information processing system having an information processing apparatus and a server communicably connected with the information processing apparatus, the control method comprising:
displaying image data obtained from the server as a first image on a display device provided in the information processing apparatus;
receiving a moving operation by a user for moving the first image displayed on the display device by an operation device provided in the information processing apparatus;
transmitting operation information regarding a moving amount by the moving operation from the information processing apparatus to the server after the moving operation is ended;
displaying a second image including a moved image in a state where the first image is moved by the moving operation and a blank image that becomes a blank in accordance with movement of the first image on the display device;
receiving the operation information from the information processing apparatus by the server;
generating image data of a third image including an image corresponding to the moved image and an image that is continuously connected to the moved image and fills the blank image by the server based on the operation information received;
transmitting the image data of the third image to the information processing apparatus; and
displaying the third image based on the image data received from the server on the display device in place of the second image.

20. A non-transitory computer-readable storage medium storing a control program causing a computer to execute a control method for a server communicably connected to an information processing apparatus, the control method comprising:
receiving operation information regarding a moving operation for moving an image displayed on a display device of the information processing apparatus, the operation information being transmitted from the information processing apparatus;
generating image data of a changed image in a state changed in accordance with the moving operation, based on the operation information received;
determining whether generation of the image data of the changed image is completed; and
waiting for transmission of the image data of the changed image to the information processing apparatus until it is determined that generation of the image data of the changed image is completed; and
transmitting the image data of the changed image to the information processing apparatus in a case where it is determined that generation of the image data of the changed image is completed.
